(19) United States
(12) Patent Application Publication
(10) Pub. No.: US 2012/0248390 A1
(43) Pub. Date: Oct. 4, 2012

(54) POLARIZER PROTECTIVE FILM, RETARDATION FILM, POLARIZER AND LIQUID-CRYSTAL DISPLAY DEVICE

(75) Inventors: Yuki MATSUDA, Kanagawa (JP); Jun TAKEDA, Kanagawa (JP); Masato MORITA, Kanagawa (JP)

(73) Assignee: FUJIFILM CORPORATION, Tokyo (JP)

(21) Appl. No.: 13/423,799

(22) Filed: Mar. 19, 2012

(30) Foreign Application Priority Data
Mar. 29, 2011 (JP) 2011-073708

(51) Int. Cl. G02B 5/30; C08B 3/00; C08B 3/06; G02F 1/1335

(52) U.S. Cl. 252/585; 349/96; 359/488.01; 536/63; 536/69

(57) ABSTRACT

A polarizer protective film containing a cellulose acylate of such that when two polarizers are arranged on both sides of the film so as to block a transmitted light from running through the film and when the film is irradiated with a light on one side thereof and observed with an optical microscope where the object lens has 10 magnifications and the eye lens has 10 magnifications, on the opposite side thereof, the number of the bright spots existing therein and having a diameter of from 0.1 μm to less than 10 μm is at most 500/cm².

### CROSS-REFERENCE TO RELATED APPLICATIONS

The present application claims the benefit of priority from Japanese Patent Application No. 2011-073708 filed on Mar. 29, 2011, the contents of which are herein incorporated by reference in their entirety.

### BACKGROUND OF THE INVENTION

1. Field of the Invention

The present invention relates to a polarizer protective film, a retardation film, a polarizer and a liquid-crystal display device.

2. Description of the Related Art

Use of liquid-crystal display devices is expanding year by year as energy-saving and space-saving image display devices. The basic constitution of the liquid-crystal display device comprises a liquid-crystal cell with a polarizer arranged on both sides of the cell. The polarizer plays a role of transmitting a light polarized in a predetermined direction alone, and the performance of a liquid-crystal display device greatly depends on the performance of the polarizer therein. The polarizer generally comprises a polarizing element with a transparent polarizer protective film stuck to both sides thereof, in which the polarizing element is formed of a polyvinyl alcohol film or the like having adsorbed iodine or dye through alignment thereon. A cellulose acylate film of typically cellulose acetate has high transparency and can readily secure airtight adhesiveness to polyvinyl alcohol used as the polarizing element, and has been widely used as a polarizer protective film.

With the recent tendency toward advancing use of liquid-crystal display devices, high-quality use of those devices for large-size TVs and others has become expanding, and development of high-image-quality and high-definition liquid-crystal display devices is being promoted. With that, polarizer protective films, retardation films and polarizers for use in liquid-crystal display devices have become desired to have much more enhanced quality.

Impurities, if any, in polarizer protective films lower the transparency of films and worsen the surface planarity thereof, therefore often detracting from the quality of films for optical use. Especially for optical films for protection of polarizers or liquid-crystal display devices, even though the film is sandwiched between two polarizers to thereby prevent a transmitted light from running therethrough but when some impurities exist in the film, the light polarization effect of the film could not sufficiently function therefore bringing about a problem in that light passes through the part where impurities exist, or that is, there is formed a bright spot in the part. The presence of such bright spots results in lowering the polarizing function of the polarizer, and when the polarizing function thereof lowers to a predetermined level or less, there occurs another problem in that the image recognition performance of the liquid-crystal display device comprising the polarizer is thereby degraded. Consequently, there is more and more increasing the demand for reducing impurities to be contained in a polarizer protective film.

Patent Reference 1 relates to a polarizer protective film formed of a cellulose ester, in which the number of the impurities having a size of from 10 μm to 50 μm and the number of the impurities having a size of more than 50 μm are specifically defined.

Patent Reference 2 relates to a cellulose ester film, in which the number of the impurities satisfying r>(d/2), where r indicates the diameter of the bright spot substance and d indicates the mean thickness of the film, is specifically defined. The thickness of the cellulose ester film described in Examples in Patent Reference 2 is 40 μm or more, and therefore, the size of the impurities of which the number is specifically defined in Patent Reference 2 is at least 20 μm.

### CITATION LIST

Patent Reference 1: JP-A 11-254466
Patent Reference 2: JP-A 2003-221455

Further recently given the situation, use of liquid-crystal display devices has become expanding even to small-sized devices that are required to reproduce high-definition images including moving images such as so-called smart phones, tablet-type computers, etc.; and those devices requires high-level definition differing from that in large-size TV use.

The present inventors tried using already-existing polarizer protective films in such high-definition liquid-crystal display devices, in which, however, there occurred bright spot failures, and the inventors knew that the already-existing polarizer protective films worsen the display performances of the devices.

The present invention is to solve the above-mentioned problems, and its object is to provide a polarizer protective film capable of preventing bright spot failures in high-definition liquid-crystal display devices.

Having specifically noted the impurities having a size of from 1 μm to less than 10 μm not specifically defined in Patent References 1 and 2, the present inventors have assiduously checked for the presence or absence of bright spot failures in high-definition liquid-crystal display devices, and have known that, when an already-existing polarizer protective film in which many bright spots having a size of from 1 μm to less than 10 μm are observed in cross-Nicol microscopy is used in a high-definition liquid-crystal display device, then there are still recognized bright spot failures in the device. The inventors have found that the impurities having a size of from 1 μm to less than 10 μm that are contained in the polarizer protective film in which many bright spots having a size of from 1 μm to less than 10 μm are observed are fibrous insoluble impurities generally contained in cellulose acylate films, and have found that the impurities are concretely hemicellulose.

Therefore, it is difficult to completely remove the impurities of the size; however, the present inventors have further promoted the investigation for reducing the number of the impurities having the size of from 1 μm to less than 10 μm, and have found that when a polarizer protective film in which the number of the impurities of the size is reduced to a level not larger than a specific number is used, then the above-mentioned problems can be solved even though the impurities of the size are not completely removed.

### SUMMARY OF THE INVENTION

As a result of assiduously studies made as above, the present inventors have found that the above-mentioned problems can be solved by the invention having the constitution mentioned below.

[1] A polarizer protective film comprising a cellulose acylate of such that when two polarizers are arranged on both sides of the film so as to block a transmitted light from running through the film and when the film is irradiated with a light on one side thereof and observed with an optical microscope where the object lens has 10 magnifications and the eye lens has 10 magnifications, on the opposite side thereof, the number of the bright spots existing therein and having a diameter of from 0.1 μm to less than 10 μm is at most 500/cm².
[2] The polarizer protective film of [1], which is a polarizer protective film for liquid-crystal display devices where the length L of the BGR short side of the panel pixel is (20 μm≦L≦100 μm) and in which the number of the bright spots as observed according to the observation method stated in [1] and having a diameter of not larger than L/10 is at most 500/cm².
[3] The polarizer protective film of [1] or [2], wherein the number of the bright spots having a diameter of from 0.1 μm to less than 10 μm is at most 150/cm².
[4] The polarizer protective film of any one of [1] to [3], wherein the number of the bright spots having a diameter of from 0.1 μm to less than 10 μm is from 11 to 150/cm².
[5] The polarizer protective film of any one of [1] to [4], wherein the number of the bright spots having a diameter of from 1 μm to less than 10 μm is from 11 to 150/cm².
[6] The polarizer protective film of any one of [1] to [5], wherein the degree of acyl substitution of the cellulose acylate is from 2.2 to 2.85.
[7] The polarizer protective film of any one of [1] to [6], of which the in-plane retardation Re at a wavelength of 590 nm satisfies −5 nm≦Re≦70 nm and the thickness-direction retardation Rth satisfies 60 nm≦Rth≦300 nm.
[8] The polarizer protective film of any one of [1] to [5], of which the in-plane retardation Re at a wavelength of 590 nm satisfies −5 nm≦Re≦5 nm and the thickness-direction retardation Rth satisfies 0 nm≦Rth≦150 nm and wherein the degree of acyl substitution of the cellulose acylate is from 2.2 to 2.5.
[9] The polarizer protective film of any one of [1] to [8], which is formed in a mode of film formation with a dope containing the cellulose acylate filtered through a filter apparatus equipped with leaf disc filters.
[10] The polarizer protective film of any one of [1] to [9], which is formed in a mode of film formation where a dope containing the cellulose acylate is cast onto a support.
[11] The polarizer protective film of any one of [1] to [10], containing a polycondensate ester.
[12] A retardation film comprising the polarizer protective film of any one of [1] to [11].
[13] A polarizer comprising a polarizing element and at least one polarizer protective film of any one of [1] to [11].
[14] A liquid-crystal display device comprising the polarizer protective film of any one of [1] to [11], the retardation film of [12] or the polarizer of [13].
[15] The liquid-crystal display device of [14], equipped with a pixel of which the length of the BGR short side is from 20 μm to 200 μm.

According to the invention, there is provided a polarizer protective film capable of preventing bright spot failures in high-definition liquid-crystal display devices.

### BRIEF DESCRIPTION OF THE DRAWINGS

FIG. 1 is a schematic view showing one embodiment of a filter apparatus usable in producing the polarizer protective film of the invention.

FIG. 2 is a schematic view showing one embodiment of a metallic filter (leaf disc filter) in a filter apparatus usable in producing the polarizer protective film of the invention.

In the drawings, 25 is filter unit, 50 is supply port, 52 is discharge port, 54 is filter housing, 56 is metal filter (leaf disc filter), 58 is filtration flow path, 60 is shaft, 61 is hole and 62 is flow channel.

### BEST MODE FOR CARRYING OUT THE INVENTION

The contents of the invention are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof. In the invention, the “diameter” of the bright spot (a small spot observed as a bright region when alight is transmitted through the film) means the diameter thereof as measured by approximating the spot into a true circle.

### [Polarizer Protective Film]

The polarizer protective film of the invention is a film comprising a cellulose acylate; and when two polarizers are arranged on both sides of the film so as to block a transmitted light from running through the film and when the film is irradiated with a light on one side thereof and observed with an optical microscope where the object lens has 10 magnifications and the eye lens has 10 magnifications, on the opposite side thereof, the number of the bright spots existing therein and having a diameter of from 0.1 μm to less than 10 μm is at most 500/cm². The bright spot means a spot of such that, when two polarizers are arranged on both sides of the cellulose ester film so as to block a transmitted light from running through the film and when the film is irradiated with a light, the light having run through the polarizer forms a spot in the film; and in general, the spot is formed because the polarizing effect of the film could not function sufficiently owing to the existence of impurities in the film. The number of the bright spots can be counted with an optical microscope (about 100 magnifications).

Preferred embodiments of the polarizer protective film of the invention are described below in point of the characteristics thereof, the production method and the materials to be used for the film.

### <Cellulose Acylate>

The starting cellulose for the cellulose acylate for use for the polarizer protective film of the invention includes cotton linter and wood pulp (hardwood pulp, softwood pulp), etc.; and any cellulose acylate obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8; and cellulose materials described in these may be used here. Cotton linter-derived cellulose contains less impurities than wood pulp-derived cellulose, but tends to be expensive. In the invention, preferred is use of a cellulose acylate obtained from linter-derived cellulose from the viewpoint of reducing impurities therein.

The cellulose acylate preferably used in the invention is described in detail. The β-1,4-bonding glucose unit to constitute cellulose has a free hydroxyl group at the 2-, 3- and 6-positions. The cellulose acylate is a polymer produced by esterifying a part or all of those hydroxyl groups in cellulose with an acyl group having 2 or more carbon atoms. The degree of acyl substitution means the total of the ratio of esterification of the hydroxyl group in cellulose positioned in the 2-, 3- and 6-positions in the unit therein. In case where the hydroxyl group is 100% esterified at each position, the degree of substitution at that position is 1.

The total degree of acyl substitution of the cellulose acylate for the polarizer protective film of the invention, or that is, DS2+DS3+DS6 thereof is preferably from 2.2 to 2.85 from the viewpoint of reducing the number of bright spots having a diameter of from 1 μm to less than 10 μm the polarizer protective film, more preferably from 2.2 to 2.7, even more preferably from 2.2 to 2.5.

Also preferably, DS6/(DS2+DS3+DS6) is from 0.08 to 0.66, more preferably from 0.15 to 0.60, even more preferably from 0.20 to 0.45. In this, DS2 means the degree of substitution of the 2-positioned hydroxyl group in the glucose unit with an acyl group (hereinafter this may be referred to as “degree of 2-acyl substitution”); DS3 means the degree of substitution of the 3-positioned hydroxyl group with an acyl group (hereinafter referred to as “degree of 3-acyl substitution”); and DS6 means the degree of substitution of the 6-positioned hydroxyl group with an acyl group (hereinafter referred to as “degree of 6-acyl substitution”). DS6/(DS2+DS3+DS6) is a ratio of the degree of 6-acyl substitution to the total degree of acyl substitution, and this may be hereinafter referred to as “proportion of 6-acyl substitution”).

Only one or two or more different types of acyl groups may be used, either singly or as combined, in the cellulose acylate for use for the polarizer protective film of the invention. In case where two or more different types of acyl groups are used, preferably, one of them is an acetyl group, and the acyl group having from 2 to 4 carbon atoms is preferably a propionyl group or a butyryl group. When sum total of the degree of substitution of the 2-positioned, 3-positioned and 6-positioned hydroxyl groups with an acetyl group is called DSA and the sum total of the degree of substitution of the 2-positioned, 3-positioned and 6-positioned hydroxyl groups with a propionyl group or a butyryl group is called DSB, then the value of DSA+DSB is preferably from 1.5 to 2.85. Preferably, the value of DSB is from 0 to 1.70, more preferably from 0 to 1.2, even more preferably from 0 to 0.5. Especially preferably in the invention, DSB is 0, or that is, the cellulose acylate is cellulose acetate. The values DSA and DSB each preferably fall within the above range, as giving a film of which the change in the Re value and the Rth value depending on the ambient humidity could be small.

Preferably, the substituent at the 6-positioned hydroxyl group accounts for at least 28% of DSB, more preferably at least 30%, even more preferably at least 31%, still more preferably at least 32%. For the film of the type, a solution having a more preferred solubility can be produced, and especially in a non-chlorine organic solvent, a good solution for the film can be formed. In addition, a solution having a further lower viscosity and therefore having better filterability can be formed.

Not specifically defined, the acyl group having at least 2 carbon atoms in the cellulose acylate for use in the invention may be an aliphatic group or an aryl group. For example, the ester is an alkylcarbonyl ester, an alkenylcarbonyl ester, an aromatic carbonyl ester or an aromatic alkylcarbonyl ester of cellulose, in which the acyl group may be further substituted. Preferred examples of the acyl group include a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group, a cinnamoyl group, etc. Of those, preferred are a propionyl group, a butanoyl group, a dodecanoyl group, an octadecanoyl group, a tert-butanoyl group, an oleoyl group, a benzoyl group, a naphthylcarbonyl group, a cinnamoyl group, etc.; more preferred are a propionyl group and a butanoyl group.

In case where an acid anhydride or an acid chloride is used as the acylating agent for acylation of cellulose, an organic acid such as acetic acid, or methylene chloride or the like may be used as the organic solvent to be the reaction solvent.

In case where the acylating agent is an acid anhydride, the catalyst is preferably a protic catalyst such as sulfuric acid; and in case where the acylating agent is an acid chloride (e.g., CH₃CH₂COCl), a basic compound may be used as the catalyst.

A most popular industrial-scale production method for a mixed fatty acid ester of cellulose comprises acylating cellulose with a mixed organic acid component that contains a fatty acid (e.g., acetic acid, propionic acid, valeric acid) corresponding to an acetyl group or other acyl group, or its acid anhydride.

The cellulose acylate for use in the invention can be produced, for example, according to the method described in JP-A 10-45804.

### <Additives>

The polarizer protective film of the invention may contain any other additive than cellulose acylate. For example, preferred additives for the film are a polycondensate ester and a retardation enhancer.

### (1) Polycondensate Ester:

The dope that contains the above-mentioned cellulose acylate preferably contains a polycondensate ester from the viewpoint of reducing the number of the bright spots existing in the polarizer protective film and having a diameter of from 0.1 μm to less than 10 μm. Not adhering to any theory, the mechanism why the number of the bright spots existing in the polarizer protective film and having a diameter of from 0.1 μm to less than 10 μm could vary owing to the addition of a polycondensate ester to the film would be because the absolute amount of cotton to be contained in the film could be reduced owing to the addition of the polycondensate ester.

As the polycondensate ester, there may be mentioned an aliphatic polycondensate ester (PA) having recurring units that comprise an aliphatic dicarboxylic acid and an aliphatic diol and optionally an aliphatic monocarboxylic acid and an aliphatic monoalcohol.

Also usable here is an aromatic polycondensate ester (PB) having recurring units that comprise an aromatic dicarboxylic acid, and an aliphatic diol or an aromatic ring-containing diol, and optionally an aliphatic monocarboxylic acid, an aliphatic monoalcohol, an aromatic ring-containing monocarboxylic acid or an aromatic ring-containing monoalcohol.

The amount of the polycondensate ester to be added is preferably from 0 to 70% by mass of the cellulose acylate, more preferably from 0 to 50% by mass, even more preferably from 0 to 30% by mass.

Preferably, the number-average molecular weight of the polycondensate ester is from 700 to 10000, more preferably from 700 to 1500, even more preferably from 700 to 1300. When the number-average molecular weight thereof is at least 700, then the polycondensate ester is poorly volatile therefore hardly causing film failures or process contamination owing to vaporization of the ester under high-temperature condition in stretching the cellulose acylate film, and this is favorable from the viewpoint of reducing the number of the bright spots existing in the polarizer protective film and having a diameter of from 1 μm to less than 10 μm. When the number-average molecular weight thereof is at most 1500, then the polycondensate ester could be highly miscible with cellulose acylate, therefore hardly bleeding out during film formation or during film stretching under heat, and this is favorable from the viewpoint of reducing the number of the bright spots existing in the polarizer protective film and having a diameter of from 1 μm to less than 10 μm.

The number-average molecular weight of the polycondensate ester for use in the invention can be measured and evaluated through gel permeation chromatography. For the polyester polyol with no end capping, the molecular weight of the compound can be computed from the amount of the hydroxyl group per weight thereof (hydroxyl value). The hydroxyl value is determined by measuring the amount of potassium hydroxide (mg) necessary for neutralizing the excessive acetic acid after acetylation of the polyester polyol.

In the invention, the dicarboxylic acid mixture of an aromatic dicarboxylic acid and an aliphatic dicarboxylic acid is preferably has a carbon number of from 5.5 to 10.0 on average, more preferably from 5.6 to 8.

When the average carbon number is at least 5.5, then a polarizer excellent in durability can be obtained. When the mean carbon number is at most 10, then the dicarboxylic acid has excellent miscibility with cellulose acylate therefore preventing the generation of bleeding out in the process of forming the cellulose acylate film.

The polycondensate ester for use in the invention may serve also as a plasticizer.

An aromatic dicarboxylic acid residue is contained in the polycondensate ester obtained from a diol and a dicarboxylic acid containing an aromatic dicarboxylic acid.

In this description, the residue means the partial structure of the polycondensate ester, indicating the partial structure having the characteristic part of the monomer that forms the polycondensate ester. For example, the dicarboxylic acid residue of a dicarboxylic acid, HOOC—R—COOH is —OC—R—CO—.

Preferably, the aromatic dicarboxylic acid residue ratio in the polycondensate ester for use in the invention is at least 40 mol %, more preferably from 45 mol % to 70 mol %, even more preferably from 50 mol % to 70 mol %.

When the aromatic dicarboxylic acid residue ratio is at least 40 mol %, then a cellulose acylate film having sufficient optical anisotropy can be obtained, and a polarizer excellent in durability can be thereby obtained.

The aromatic dicarboxylic acid for use in the invention includes, for example, phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, 2,6-naphthalenedicarboxylic acid, etc. Preferred are phthalic acid, terephthalic acid and 2,6-naphthalenedicarboxylic acid; more preferred are phthalic acid and terephthalic acid; and even more preferred is terephthalic acid.

In the polycondensate ester, the aromatic dicarboxylic acid used as a mixture thereof forms the aromatic dicarboxylic acid residue therein.

Concretely, the aromatic dicarboxylic acid residue preferably contains at least one of a phthalic acid residue, a terephthalic acid residue and an isophthalic acid residue, more preferably at least one of a phthalic acid residue and a terephthalic acid residue, even more preferably a terephthalic acid residue.

Specifically, when terephthalic acid is used as the aromatic dicarboxylic acid in the form a mixture thereof in forming the polycondensate ester, then it is excellent in miscibility with cellulose acylate therefore providing a cellulose acylate film hardly causing bleeding out in film formation of the cellulose acylate film and in stretching the film under heat. One or more different types of aromatic dicarboxylic acids may be used here; and in case where two or more are used, preferred is a combination of phthalic acid and terephthalic acid.

Combined use of two aromatic dicarboxylic acids of phthalic acid and terephthalic acid is preferred since the polycondensate ester is soft at room temperature and is easy to handle.

In the invention, the terephthalic acid residue content in the dicarboxylic acid residue in the polycondensate ester is preferably at least 40 mol %, more preferably from 45 mol % to 70 mol %, even more preferably from 50 mol % to 70 mol %.

When the terephthalic acid residue content is at least 40 mol %, then a cellulose acylate film having sufficient optical anisotropy can be obtained.

An aliphatic dicarboxylic acid residue is contained in the polycondensate ester obtained from a diol and a dicarboxylic acid containing an aliphatic dicarboxylic acid.

In this description, the residue means the partial structure of the polycondensate ester, indicating the partial structure having the characteristic part of the monomer that forms the polycondensate ester. For example, the dicarboxylic acid residue of a dicarboxylic acid, HOOC—R—COOH is —OC—R—CO—.

The aliphatic dicarboxylic acid preferred for use in the invention includes, for example, oxalic acid, malonic acid, succinic acid, maleic acid, fumaric acid, glutaric acid, adipic acid, pimelic acid, suberic acid, azelaic acid, sebacic acid, dodecane-dicarboxylic acid, 1,4-cyclohexane-dicarboxylic acid, etc.

In the polycondensate ester, the aliphatic dicarboxylic acid used as a mixture thereof forms the aliphatic dicarboxylic acid residue therein.

The mean carbon number of the dicarboxylic acid residue is preferably from 5.5 to 10.0, more preferably from 5.5 to 8.0, even more preferably from 5.5 to 7.0. When the mean carbon number of the aliphatic diol is at most 7.0, the heat loss of the compound can be reduced, and surface failures of the film, which are considered to be because of the process contamination owing to bleeding out in drying the cellulose acylate web, can be reduced. When the mean carbon number of the aliphatic diol is at least 2.5, then the diol is preferred as having excellent miscibility and therefore the polycondensate ester forms few deposits in the film.

Concretely, the ester preferably contains a succinic acid residue; and in case where two or more different types of dicarboxylic acids are used, the polycondensate ester preferably contains a succinic acid residue and an adipic acid residue.

Specifically, one or more different types of aliphatic dicarboxylic acids may be used as a mixture thereof in forming the polycondensate ester; and in case where two or more are used, preferred is a combination of succinic acid and adipic acid. In case where one aliphatic dicarboxylic acid is used, preferred is use of succinic acid. This is preferred since the mean carbon number of the diol residue can be controlled to a desired value and the polycondensate ester is well miscible with cellulose acylate.

In the invention, preferably, two or three different types of dicarboxylic acids are used. In case where two dicarboxylic acids are used, preferred is use of one aliphatic dicarboxylic acid and one aromatic dicarboxylic acid; and in case where three dicarboxylic acids are used, there may be mentioned use of one aliphatic dicarboxylic acid and two aromatic dicarboxylic acids, or use of two aliphatic dicarboxylic acids and one aromatic dicarboxylic acid. This makes it easy to control the mean carbon number of the dicarboxylic acid residue and to control the content of the aromatic dicarboxylic acid residue within a preferred range, and therefor facilitates the handling of the film.

An aliphatic diol residue is contained in the polycondensate ester obtained from an aliphatic diol and a dicarboxylic acid.

In this description, the residue means the partial structure of the polycondensate ester, indicating the partial structure having the characteristic part of the monomer that forms the polycondensate ester. For example, the diol residue of a diol, HO—R—OH is —O—R—O—.

The diol to form the polycondensate ester includes an aromatic diol and an aliphatic diol.

Preferably, the polycondensate ester contains an aliphatic diol residue having a mean carbon number of from 2.5 to 7.0. More preferred is an aliphatic diol residue having a mean carbon number of from 2.5 to 4.0. When the mean carbon number of the aliphatic diol residue is at most 3.0, then the miscibility of the ester with cellulose acylate does not lower and therefore bleeding out hardly occurs during film formation; and in addition, the heat loss of the compound does not increase too much, and surface failures of the film, which are considered to be because of the process contamination in drying the cellulose acylate web, would hardly occur. When the mean carbon number of the aliphatic diol residue is less than 2.0, the ester production would be difficult.

As the aliphatic diol for use in the invention, there may be mentioned an alkyl diol and an alicyclic diol, including, for example, ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, diethylene glycol, cyclohexanedimethanol, etc. Preferably, these are used singly or as a mixture of two or more of them along with ethylene glycol.

As the aliphatic diol, preferred is at least one of ethylene glycol, 1,2-propanediol and 1,3-propanediol, and more preferred is at least one of ethylene glycol and 1,2-propanediol. In case where two diols are used, preferred is a combination of ethylene glycol and 1,2-propanediol. Use of 1,2-propanediol or 1,3-propanediol prevents crystallization of the polycondensate ester.

In the polycondensate ester, a diol residue is formed from the diol used as a mixture thereof.

Preferably, the diol residue contains at least one of an ethylene glycol residue, a 1,2-propanediol residue and a 1,3-propanediol residue, and is more preferably an ethylene glycol residue or a 1,2-propanediol residue.

Of the aliphatic diol residue, preferably, the ethylene glycol residue accounts for from 20 mol % to 100 mol %, more preferably from 50 mol % to 100 mol %.

For the aliphatic diol for use in the aromatic polymer plasticizer (PB), also usable is the aliphatic diol mentioned above for the aliphatic polymer plasticizer (PA), and an alkyl ether diol having from 4 to 20 carbon atoms is also usable in the aromatic polymer plasticizer (PB).

In the aromatic polymer plasticizer (PB), an aromatic ring-containing diol is also usable as the diol. As the aromatic ring-containing diol, preferred is at least one diol selected from aromatic diols having from 6 to 20 carbon atoms, and there are mentioned bisphenol A, 1,2-dihydroxybenzene, 1,3-dihydroxybenzene, 1,4-dihydroxybenzene and benzene-1,4-dimethanol. Preferred are bisphenol A, 1,4-dihydroxybenzene and benzene-1,4-dimethanol.

Further in the aromatic polymer plasticizer (PB), preferred is optional use of an aliphatic monocarboxylic acid, an aliphatic monoalcohol, an aromatic ring-containing monocarboxylic acid or an aromatic ring-containing monoalcohol. In the case, as the aliphatic monocarboxylic acid and the aliphatic monoalcohol, usable are the aliphatic monocarboxylic acid and the aliphatic monoalcohol mentioned above for the aliphatic polymer plasticizer (PA), and an alkyl ether diol having from 4 to 20 carbon atoms is also usable in the aromatic polymer plasticizer (PB).

The aromatic ring-containing monoalcohol preferably contains at least one selected from an aromatic ring-containing group having from 6 to 20 carbon atoms, an aliphatic carbonyl group having from 2 to 22 carbon atoms, and an aromatic carbonyl group having from 7 to 20 carbon atoms; and for example, there are mentioned phenol, cresol, benzyl alcohol, phenylethanol, phenethyl alcohol, 1-naphthyl alcohol, etc. Preferred are benzyl alcohol and phenylethanol.

The aromatic ring-containing monocarboxylic acid preferably contains at least one selected from an aromatic ring-containing group having from 6 to 20 carbon atoms, an aliphatic carbonyl group having from 2 to 22 carbon atoms, and an aromatic carbonyl group having from 7 to 20 carbon atoms, and for example, includes benzoic acid, p-tert-butylbenzoic acid, p-tert-amylbenzoic acid, orthotoluic acid, metatoluic acid, paratoluic acid, dimethylbenzoic acid, ethyl benzoate, n-propyl benzoate, aminobenzoic acid, acetoxybenzoic acid, phenylacetic acid, cinnamic acid, etc. Preferred are benzoic acid, phenylacetic acid and cinnamic acid. One or more of these may be used here.

The polycondensate ester for use in the invention is not end-capped and is in the form of a diol or a carboxylic acid; however, a monocarboxylic acid or a monoalcohol may be reacted with the ester for end capping.

The monocarboxylic acid for use for end capping is preferably acetic acid, propionic acid or butanoic acid, more preferably acetic acid or propionic acid, most preferably acetic acid. The monoalcohol for use for end capping is preferably methanol, ethanol, propanol, isopropanol, butanol or isobutanol, most preferably methanol. When the carbon number of the monocarboxylic acid for use for end-capping the polycondensate ester is at most 3, then the heat loss of the compound does not increase and film surface failures do not occur.

More preferably, the polycondensate ester for use in the invention is not end-capped and a diol residue remains as such on the end of the ester, but more preferably, the ester is end-capped with acetic acid or propionic acid.

Anyhow, the polycondensate ester for use in the invention may be or may not be end-capped on both ends thereof.

In case where both ends thereof are capped, the polycondensate ester is preferably a polyester polyol.

One embodiment of the polycondensate ester for use in the invention is a polycondensate ester where the carbon number of the aliphatic diol residue is from 2.5 to 7.0 and both ends of the ester are not capped.

In case where both ends of the polycondensate ester are capped, preferably, the ester is reacted with a monocarboxylic acid for end-capping. In this case, both ends of the polycondensate ester each are a monocarboxylic acid residue. In this description, the residue means the partial structure of the polycondensate ester, indicating the partial structure having the characteristic part of the monomer that forms the polycondensate ester. For example, the monocarboxylic acid residue of a monocarboxylic acid, R—COOH is R—CO—. Preferred here is an aliphatic monocarboxylic acid residue, more preferred is an aliphatic monocarboxylic acid residue having at most 22 carbon atoms, even more preferred is an aliphatic monocarboxylic acid residue having at most 3 carbon atoms. Also preferred is an aliphatic monocarboxylic acid residue having at least 2 carbon atoms, and more preferred is an aliphatic monocarboxylic acid residue having 2 carbon atoms.

One embodiment of the polycondensate ester for use in the invention is a polycondensate ester where the carbon number of the aliphatic diol residue is from more than 2.5 to 7.0 and both ends of the ester each are a monocarboxylic acid residue.

When the carbon number of monocarboxylic acid residue at both ends of the polycondensate ester is at most 3, then the polycondensate ester is poorly volatile and the weight loss in heating thereof does not increase, and therefore the troubles of process contamination and film surface failures could be reduced.

Specifically, aliphatic monocarboxylic acids are preferred for end-capping. More preferred are aliphatic monocarboxylic acids having from 2 to 22 carbon atoms, even more preferred are aliphatic monocarboxylic acids having from 2 to 3 carbon atoms, and especially preferred are aliphatic monocarboxylic acids having 2 carbon atoms.

For example, preferred are acetic acid, propionic acid, butanoic acid, benzoic acid and their derivatives, more preferred are acetic acid and propionic acid, and most preferred is acetic acid.

Two or more different types of monocarboxylic acids may be used here for end-capping.

Preferably, the polycondensate ester for use in the invention are end-capped with acetic acid or propionic acid at both ends thereof, and most preferably, both ends of the polycondensate ester each are an acetyl ester residue (also referred to as acetyl residue) through end-capping with acetic acid.

In case where both ends thereof are end-capped, the polycondensate ester could hardly be solid at room temperature and its handlability is good, and in addition, a cellulose acylate film excellent in moisture stability and polarizer durability can be obtained.

Specific examples of the polycondensate ester for use in the invention are shown below, to which, however, the invention is not limited.

### <<Aliphatic Polycondensate Ester (PA)>>

PA-1: condensate of ethylene glycol/succinic acid (1/1 by mol) (number-average molecular weight 1100).
PA-2: condensate of 1,3-propanediol/glutaric acid (1/1 by mol) (number-average molecular weight 1500).
PA-3: condensate of 1,3-propanediol/adipic acid (1/1 by mol) (number-average molecular weight 900).
PA-4: condensate of 1,3-propanediol/ethylene glycol/adipic acid (1/1/2 by mol) (number-average molecular weight 1500).
PA-5: condensate of 2-methyl-1,3-propanediol/adipic acid (1/1 by mol) (number-average molecular weight 1400).
PA-6: both-end-acetylated condensate of ethylene glycol/succinic acid/adipic acid (2/1/1 by mol) (number-average molecular weight 1000).
PA-7: condensate of 1,4-cyclohexanediol/succinic acid (1/1 by mol) (number-average molecular weight 1800).
PA-8: both-end-butyl-esterified condensate of 1,3-propanediol/succinic acid (1/1 by mol) (number-average molecular weight 1200).
PA-9: both-end-cyclohexyl-esterified condensate of 1,3-propanediol/glutaric acid (1/1 by mol) (number-average molecular weight 1500).
PA-10: both-end-acetylated condensate of ethylene glycol/succinic acid (1/1 by mol) (number-average molecular weight 3000).
PA-11: both-end-isononyl-esterified condensate of 1,3-propanediol/ethylene glycol/adipic acid (1/1/2 by mol) (number-average molecular weight 1500).
PA-12: both-end-propyl-esterified condensate of 2-methyl-1,3-propanediol/adipic acid (1/1 by mol) (number-average molecular weight 1300).
PA-13: both-end-acetylated condensate of 2-methyl-1,3-propanediol/adipic acid (1/1 by mol) (number-average molecular weight 1700).
PA-14: both-end-isononyl-esterified condensate of 2-methyl-1,3-propanediol/adipic acid (1/1 by mol) (number-average molecular weight 1500).
PA-15: both-end-butyl-esterified condensate of 1,4-butanediol/adipic acid (1/1 by mol) (number-average molecular weight 1100).
PA-16: condensate of poly(mean degree of polymerization 5)propylene ether glycol/succinic acid (1/1 by mol) (number-average molecular weight 2800).
PA-17: condensate of poly(mean degree of polymerization 3)ethylene ether glycol/glutaric acid (1/1 by mol) (number-average molecular weight 2300).
PA-18: condensate of poly(mean degree of polymerization 4)propylene ether glycol/adipic acid (1/1 by mol) (number-average molecular weight 2200).
PA-19: both-end-butyl-esterified condensate of poly(mean degree of polymerization 5)propylene ether glycol/succinic acid (1/1 by mol) (number-average molecular weight 1900).
PA-20: both-end-2-ethylhexyl-esterified condensate of poly(mean degree of polymerization 3)ethylene ether glycol/glutaric acid (1/1 by mol) (number-average molecular weight 2500).
PA-21: both-end-acetylated condensate of poly(mean degree of polymerization 4)propylene ether glycol/adipic acid (1/1 by mol) (number-average molecular weight 1500).
PA-22: both-end-propionylated condensate of poly(mean degree of polymerization 4) propylene ether glycol/phthalic acid (1/1 by mol) (number-average molecular weight 1900).
PA-23: condensate of ethylene glycol/adipic acid (1/1 by mol) (number-average molecular weight 1000).

### <<Aromatic Polymer Plasticizer (PB)>>

PB-1: condensate of succinic acid/phthalic acid/ethylene glycol (1/1/2 by mol) (number-average molecular weight 900).
PB-2: condensate of glutaric acid/isophthalic acid/1,3-propanediol (1/1/2 by mol) (number-average molecular weight 1300).
PB-3: condensate of adipic acid/terephthalic acid/1,2-propanediol (1/1/2 by mol) (number-average molecular weight 1200).
PB-4: condensate of succinic acid/terephthalic acid/ethylene glycol/1,4-cyclohexanedimethanol (1/1/1/1 by mol) (number-average molecular weight 3000).
PB-5: condensate of succinic acid/glutaric acid/terephthalic acid/isophthalic acid/ethylene glycol/1,2-propanediol (1/1/1/1/1/3/2 by mol) (number-average molecular weight 2500).
PB-6: condensate of succinic acid/adipic acid/terephthalic acid/ethylene glycol/1,2-propanediol (1/1/1/2/1 by mol) (number-average molecular weight 2800).
PB-7: condensate of succinic acid/adipic acid/1,4-naphthalenedicarboxylic acid/ethylene glycol/1,2-propanediol (1/1/1/2/1 by mol) (number-average molecular weight 2000).
PB-8: condensate of succinic acid/terephthalic acid/poly (mean degree of polymerization 5)propylene ether glycol/1,2-propanediol (2/1/1/2 by mol) (number-average molecular weight 2500).
PB-9: condensate of succinic acid/terephthalic acid/poly (mean degree of polymerization 3)ethylene ether glycol/1,2-propanediol (1/3/2/2 by mol) (number-average molecular weight 3500).
PB-10: both-end-acetylated condensate of succinic acid/terephthalic acid/ethylene glycol (1/1/2 by mol) (number-average molecular weight 2100).
PB-11: both-end-cyclohexyl-esterified condensate of glutaric acid/isophthalic acid/1,3-propanediol (1/1/2 by mol) (number-average molecular weight 1500).
PB-12: both-end-2-ethylhexyl-esterified condensate of adipic acid/terephthalic acid/1,2-propanediol (1/1/2 by mol) (number-average molecular weight 2500).
PB-13: both-end-isononyl-esterified condensate of succinic acid/terephthalic acid/ethylene glycol/1,4-cyclohexanedimethanol (1/1/1/1 by mol) (number-average molecular weight 3000).
PB-14: both-end-propyl-esterified condensate of succinic acid/glutaric acid/adipic acid/terephthalic acid/isophthalic acid/ethylene glycol/1,2-propanediol (1/1/1/1/1/3/2 by mol) (number-average molecular weight 3000).
PB-15: both-end-2-ethylhexyl-esterified condensate of succinic acid/adipic acid/terephthalic acid/ethylene glycol/1,2-propanediol (1/1/1/2/1 by mol) (number-average molecular weight 3000).
PB-16: both-end-benzoated condensate of succinic acid/adipic acid/1,4-naphthalenedicarboxylic acid/ethylene glycol/1,2-propanediol (1/1/1/2/1 by mol) (number-average molecular weight 3000).
PB-17: both-end-2-ethylhexyl-esterified condensate of succinic acid/terephthalic acid/poly(mean degree of polymerization 5)propylene ether glycol/1,2-propanediol (2/1/1/2 by mol) (number-average molecular weight 3500).
PB-18: both-end-2-ethylhexyl-esterified condensate of succinic acid/terephthalic acid/poly(mean degree of polymerization 4)ethylene ether glycol/1,2-propanediol (1/3/2/2 by mol) (number-average molecular weight 2500).
PB-19: both-end-acetylated condensate of succinic acid/phthalic acid/ethylene glycol (1/1/2 by mol) (number-average molecular weight 2500).
PB-20: both-end-acetylated condensate of succinic acid/isophthalic acid/phthalic acid/terephthalic acid/ethylene glycol/1,3-propanediol (1/1/1/1/2/2 by mol) (number-average molecular weight 1300).
PB-21: both-end-benzoylated condensate of adipic acid/terephthalic acid/1,2-propanediol (1/1/2 by mol) (number-average molecular weight 900).
PB-22: both-end-propionylated condensate of succinic acid/terephthalic acid/ethylene glycol/1,4-cyclohexanedimethanol (1/1/1/1 by mol) (number-average molecular weight 3000).
PB-23: both-end-cyclohexanecarbonylated condensate of succinic acid/glutaric acid/adipic acid/terephthalic acid/isophthalic acid/ethylene glycol/1,2-propanediol (1/1/1/1/2/3/3 by mol) (number-average molecular weight 2500).
PB-24: both-end-acetylated condensate of succinic acid/terephthalic acid/poly(mean degree of polymerization 3)ethylene ether glycol/1,2-propanediol (1/3/2/2 by mol) (number-average molecular weight 2500).
PB-25: condensate of succinic acid/bisphenol A (1/1 by mol) (number-average molecular weight 2000).
PB-26: condensate of succinic acid/terephthalic acid/ethylene glycol/bisphenol A (2/1/1/2 by mol) (number-average molecular weight 2500).
PB-27: condensate of succinic acid/2,6-naphthalenedicarboxylic acid/bisphenol A/propanediol (1/2/2/1 by mol) (number-average molecular weight 1900).
PB-28: condensate of succinic acid/adipic acid/2,6-naphthalenedicarboxylic acid/bisphenol A/diethylene glycol (1/1/2/2/2 by mol) (number-average molecular weight 2500).
PB-29: both-end-2-ethylhexyl-esterified condensate of succinic acid/terephthalic acid/ethylene glycol/bisphenol A (1/2/1/2 by mol) (number-average molecular weight 2500).
PB-30: both-end-2-ethylhexyl-esterified condensate of succinic acid/2,6-naphthalenedicarboxylic acid/bisphenol A/propanediol (1/2/2/1 by mol) (number-average molecular weight 2300).
PB-31: both-end-acetylated condensate of succinic acid/bisphenol A (1/1 by mol) (number-average molecular weight 2200).
PB-32: both-end-acetylated condensate of succinic acid/adipic acid/phthalic acid/terephthalic acid/ethylene glycol (5/5/1/9/20 by mol) (number-average molecular weight 800).
PB-33: both-end-acetylated condensate of adipic acid/phthalic acid/terephthalic acid/ethylene glycol (10/5/1/9/20 by mol) (number-average molecular weight 800).
PB-34: both-end-acetylated condensate of adipic acid/phthalic acid/terephthalic acid/ethylene glycol (5/2/3/10 by mol) (number-average molecular weight 1000).
PB-35: both-end-acetylated condensate of succinic acid/adipic acid/phthalic acid/ethylene glycol (1/1/2/4 by mol) (number-average molecular weight 1000).

### (2) Retardation Enhancer:

The polarizer protective film of the invention may contain a retardation enhancer for expressing the retardation value thereof. Not specifically defined, the retardation enhancer includes rod-shaped or discotic compounds. Rod-shaped or discotic compounds having at least two aromatic rings are preferred for the retardation enhancer.

Preferably, the amount to be added of the retardation enhancer comprising a rod-shaped compound is from 0.1 parts by mass to less than 3 parts by mass relative to 100 parts by mass of the cellulose acylate ingredient, more preferably from 0.5 parts by mass to less than 2 parts by mass. On the other hand, the amount to be added of the retardation enhancer comprising a discotic compound is preferably from 0 to 10% by mass of the cellulose acylate, more preferably from 0.5 to 4% by mass, even more preferably from 1 to 3% by mass.

Discotic compounds are better than rod-shaped compound in point of the Rth retardation expressibility, and therefore the former are used in a case where an especially large Rth retardation is needed. Two or more different types of retardation enhancers may be combined for use herein.

Preferably, the retardation enhancer has a maximum absorption in a wavelength range of from 250 to 400 nm; and also preferably, it does not have any substantial absorption in a visible range.

Discotic compounds are described. Discotic compounds having at least two aromatic rings are usable here.

In this description, “aromatic ring” includes not only an aromatic hydrocarbon ring but also an aromatic hetero ring.

The aromatic hydrocarbon ring is especially preferably a 6-membered ring (or that is, benzene ring).

The aromatic hetero ring is generally an unsaturated hetero ring. The aromatic hetero ring is preferably a 5-membered ring, a 6-membered ring or a 7-membered ring, and more preferably a 5-membered ring or a 6-membered ring. The aromatic hetero ring generally has a largest number of double bonds. As the hetero atom, preferred are a nitrogen atom, an oxygen atom and a sulfur atom, and more preferred is a nitrogen atom. Examples of the aromatic hetero ring include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic ring, preferred are a benzene ring, a condensed benzene ring and biphenyls. Especially preferred is a 1,3,5-triazine ring. Concretely, for example, use of the compounds disclosed in JP-A 2001-166144 is preferred here.

Preferably, the carbon number of the aromatic ring that the retardation enhancer has is from 2 to 20, more preferably from 2 to 12, even more preferably from 2 to 8, most preferably from 2 to 6.

The bonding mode of two aromatic rings in the retardation enhancer includes (a) a case of forming a condensed ring, (b) a case of direct bonding via a single bond, and (c) a case of bonding via a linking group (aromatic rings could not form a spiro bond). Any of those bonding modes (a) to (c) is employable here.

Examples of condensed ring of the case (a) (condensed rings of two or more aromatic rings) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolidine ring, a benzoxazole ring, a benzothiazole ring, a benzimidazole ring, a benzotriazole ring, a purine ring, a indazole ring, a chromene ring, a quinoline ring, an isoquinoline ring, a quinolidine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathine ring, phenoxazine ring and a thianthrene ring. Preferred are a naphthalene ring, an azulene ring, an indole ring, a benzoxazole ring, a benzothiazole ring, a benzimidazole ring, a benzotriazole ring and a quinoline ring.

The single bond in (b) is preferably a bond between the carbon atoms of two aromatic rings. Two aromatic rings may be bonded via 2 or more single bonds, thereby forming an aliphatic ring or a non-aromatic hetero ring between the two aromatic rings.

Also preferably, the linking group in (c) is to link the carbon atoms of two aromatic rings. The linking group is preferably an alkylene group, an alkenylene group, an alkynylene group, —CO—, —O—, —NH—, —S— or a combination thereof. Examples of the linking group comprising a combination of the above groups are shown below. Regarding the relationship therebetween, the right side and the left side groups in the examples of linking groups mentioned below may be reversed to each other.

c1: —CO—O—

c2: —CO—NH—

c3: -alkylene-O—

c4: —NH—CO—NH—

c5: —NH—CO—O—

c6: —O—CO—O—

c7: —O-alkylene-O—

c8: —CO-alkenylene-

c9: —CO-alkenylene-NH—

c10: —CO-alkenylene-O—

c11: -alkylene-CO—O-alkylene-O—CO-alkylene-

c12: —O-alkylene-CO—O-alkylene-O—CO-alkylene-O—

c13: —O—CO-alkylene-CO—O—

c14: —NH—CO-alkenylene-

c15: —O—CO-alkenylene-

The aromatic ring and the linking group may have a substituent.

Examples of the substituent include a halogen atom (F, Cl, Br, I), a hydroxyl group, a carboxyl group, a cyano group, an amino group, a nitro group, a sulfo group, a carbamoyl group, a sulfamoyl group, an ureido group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfonamide group, an aliphatic substituted amino group, an aliphatic substituted carbamoyl group, an aliphatic substituted sulfamoyl group, an aliphatic substituted ureido group and a non-aromatic heterocyclic group.

Preferably, the carbon number of the alkyl group is from 1 to 8. As the alkyl group, preferred is a chain-like alkyl group rather than a cyclic alkyl group, and more preferred is a linear alkyl group. The alkyl group may be further substituted (for example, with a hydroxy group, a carboxyl group, an alkoxy group, or an alkyl-substituted amino group). Examples of the alkyl group (including substituted alkyl group) include a methyl group, an ethyl group, an n-butyl group, an n-hexyl group, a 2-hydroxyethyl group, a 4-carboxybutyl group, a 2-methoxyethyl group and a 2-diethylaminoethyl group.

Preferably, the carbon number of the alkenyl group is from 2 to 8. As the alkenyl group, preferred is a chain-like alkenyl group rather than a cyclic alkenyl group, and more preferred is a linear alkenyl group. The alkenyl group may be further substituted. Examples of the alkenyl group include a vinyl group, an allyl group and a 1-hexenyl group.

Preferably, the carbon number of the alkynyl group is from 2 to 8. As the alkynyl group, preferred is a chain-like alkynyl group rather than a cyclic alkynyl group, and more preferred is a linear alkynyl group. The alkynyl group may be further substituted. Examples of the alkynyl group include an ethynyl group, a 1-butynyl group and a 1-hexynyl group.

Preferably, the carbon number of the aliphatic acyl group is from 1 to 10. Examples of the aliphatic acyl group include an acetyl group, a propanoyl group and a butanoyl group.

Preferably, the carbon number of the aliphatic acyloxy group is from 1 to 10. Examples of the aliphatic acyloxy group include an acetoxy group.

Preferably, the carbon number of the alkoxy group is from 1 to 8. The alkoxy group may be further substituted (for example, with an alkoxy group). Examples of the alkoxy group (including substituted alkoxy group) include a methoxy group, an ethoxy group, a butoxy group and a methoxyethoxy group.

Preferably, the carbon number of the alkoxycarbonyl group is from 2 to 10. Examples of the alkoxycarbonyl group include a methoxycarbonyl group and an ethoxycarbonyl group.

Preferably, the carbon number of the alkoxycarbonylamino group is from 2 to 10. Examples of the alkoxycarbonylamino group include a methoxycarbonylamino group and an ethoxycarbonylamino group.

Preferably, the carbon number of the alkylthio group is from 1 to 12. Examples of the alkylthio group include a methylthio group, an ethylthio group and an octylthio group.

Preferably, the carbon number of the alkylsulfonyl group is from 1 to 8. Examples of the alkylsulfonyl group include a methanesulfonyl group and an ethanesulfonyl group.

Preferably, the carbon number of the aliphatic amide group is from 1 to 10. Examples of the aliphatic amide group include an acetamide group.

Preferably, the carbon number of the aliphatic sulfonamide group is from 1 to 8. Examples of the aliphatic sulfonamide group include a methanesulfonamide group, a butanesulfonamide group and an n-octanesulfonamide group.

Preferably, the carbon number of the aliphatic substituted amino group is from 1 to 10. Examples of the aliphatic substituted amino group include a dimethylamino group, a diethylamino group and a 2-carboxyethylamino group.

Preferably, the carbon number of the aliphatic substituted carbamoyl group is from 2 to 10. Examples of the aliphatic substituted carbamoyl group include a methylcarbamoyl group and a diethylcarbamoyl group.

Preferably, the carbon number of the aliphatic substituted sulfamoyl group is from 1 to 8. Examples of the aliphatic substituted sulfamoyl group include a methylsulfamoyl group and a diethylsulfamoyl group.

Preferably, the carbon number of the aliphatic substituted ureido group is from 2 to 10. Examples of the aliphatic substituted ureido group include a methylureido group.

Examples of the non-aromatic heterocyclic group include a piperidino group and a morpholino group.

Preferably, the molecular weight of the retardation enhancer is from 300 to 800.

In the invention, as the discotic compound, preferred is use of triazine compounds represented by the following general formula (I):

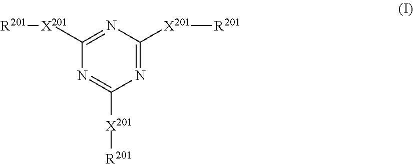

In the above formula (I),

R²⁰¹ each independently represents an aromatic ring or a hetero ring having a substituent at any of ortho-, meta- and para-positions.

X²⁰¹ each independently represents a single bond or —NR²⁰²—.

In this, R²⁰² each independently represent a hydrogen atom, or a substituted or unsubstituted alkyl, alkenyl, aryl or heterocyclic group.

Preferably, the aromatic ring represented by R²⁰¹ is phenyl or naphthyl, more preferably phenyl. The aromatic ring represented by R²⁰¹ is may have at least one substituent at any substitution position thereof. Examples of the substituent include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamide group, a carbamoyl group, an alkyl-substituted carbamoyl group, an alkenyl-substituted carbamoyl group, an aryl-substituted carbamoyl group, an amide group, an alkylthio group, an alkenylthio group, an arylthio group and an acyl group.

The heterocyclic group represented by R²⁰¹ is preferably aromatic. The aromatic hetero ring is generally an unsaturated hetero ring and is preferably a hetero ring having a largest number of double bonds. Preferably, the hetero ring is a 5-membered ring, a 6-membered ring or a 7-membered ring, more preferably a 5-membered ring or a 6-membered ring, most preferably a 6-membered ring. Preferably, the hetero atom of the hetero ring is a nitrogen atom, a sulfur atom or an oxygen atom, more preferably a nitrogen atom. As the aromatic hetero ring, especially preferred is a pyridine ring (as the heterocyclic group thereof, 2-pyridyl or 4-pyridyl). The heterocyclic group may have a substituent. Examples of the substituent of the heterocyclic group are the same as those of the substituent of the above-mentioned aryl moiety.

The heterocyclic group in a case where X²⁰¹ is a single bond is preferably a heterocyclic group having a free atomic valence at the nitrogen atom thereof. The heterocyclic group having a free atomic valence at the nitrogen atom thereof is preferably a 5-membered ring, a 6-membered ring or a 7-membered ring, more preferably a 5-membered ring or a 6-membered ring, most preferably a 5-membered ring. The heterocyclic group may have multiple nitrogen atoms. The heterocyclic group may have any other hetero atom (e.g., O, S) than the nitrogen atom. Examples of the heterocyclic group having a free atomic valence at the nitrogen atom thereof are mentioned below. In these, —C₄H₉ⁿ means n-C₄H₉.

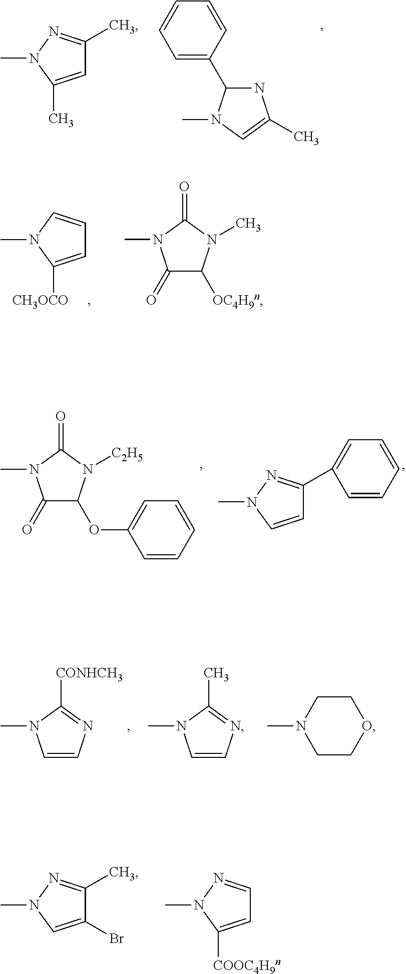

The alkyl group represented by R²⁰² may be a cyclic alkyl group or a chain-like alkyl group, but is preferably a chain-like alkyl group, more preferably a linear alkyl group rather than a branched chain-like alkyl group. The carbon number of the alkyl group is preferably from 1 to 30, more preferably from 1 to 20, even more preferably from 1 to 10, still more preferably from 1 to 8, most preferably from 1 to 6. The alkyl group may have a substituent. Examples of the substituent include a halogen atom, an alkoxy group (for example, methoxy group, ethoxy group) and an acyloxy group (for example, acryloyloxy group, methacryloyloxy group).

The alkenyl group represented by R²⁰² may be a cyclic alkenyl group or a chain-like alkenyl group, but is preferably a chain-like alkenyl group, more preferably a linear alkenyl group rather than a branched chain-like alkenyl group. The carbon number of the alkenyl group is preferably from 2 to 30, more preferably from 2 to 20, even more preferably from 2 to 10, still more preferably from 2 to 8, most preferably from 2 to 6. The alkenyl group may have a substituent. Examples of the substituent are the same as those of the substituent of the alkyl group mentioned above.

The aromatic cyclic group and the heterocyclic group represented by R²⁰² are the same as the aromatic ring and the hetero ring represented by R²⁰¹, and preferred examples of the former are also the same as those of the latter. The aromatic cyclic group and the heterocyclic group may be further substituted, and examples of the substituent for these are the same as those of the substituent for the aromatic cyclic group and the heterocyclic group of R²⁰¹.

The compounds represented by the general formula (I) may be produced in any known methods, for example, according to the method described in JP-A 2003-344655, etc. The details of the retardation enhancer are described in Disclosure Bulletin No. 2001-1745, p. 49.

As the retardation enhancer in the invention, also usable is a polymer additive like the above-mentioned low-molecular compound. In the invention, the polycondensate ester polymer mentioned hereinabove may serve additionally as a polymer retardation enhancer. As the polymer retardation enhancer of the above-mentioned polycondensate ester, preferred is the above-mentioned aromatic polyester polymer and a copolymer of the aromatic polyester polymer with any other resin.

Preferably, the retardation enhancer in the invention is an Re enhancer from the viewpoint of efficiently enhancing Re of the film. As the Re enhancer of the above-mentioned retardation enhancer, for example, there are mentioned discotic compounds and rod-shaped compounds.

### <Production Method for Polarizer Protective Film>

The production method for the polarizer protective film of the invention is not specifically defined.

Preferably, the polarizer protective film of the invention is formed of a dope that contains the above-mentioned cellulose acylate filtered through a filter unit equipped with leaf disc filters. Also preferably, the polarizer protective film of the invention is formed by casting the dope that contains the above-mentioned cellulose acylate onto a support.

The production method for the polarizer protective film of the invention is described below.

### (Preparation of Dope)

First, the starting resin is dissolved in a suitable organic solvent to prepare a solution (dope) of a cellulose ester. Examples of the organic solvent include halogenohydrocarbons (dichloromethane, etc.), alcohols (methanol, ethanol, butanol, etc.), esters (methyl formate, methyl acetate, etc.), ethers (dioxane, dioxolan, diethyl ether, etc.). Apart from the polycondensate ester and the retardation enhancer, any known plasticizer such as triphenyl phosphate, diethyl phthalate, polyester polyurethane elastomer or the like may be added to the cellulose ester solution, and further optionally, any known additive such as UV absorbent, antioxidant, lubricant, release promoter and the like may also be added thereto.

The solvent to be used in the dope in the production method in the invention may be any known solvent for general use for solution casting; however, for further reducing the haze of the film to be formed, preferred is use of a solvent selected from ethers having from 3 to 12 carbon atoms, ketones having from 3 to 12 carbon atoms, esters having from 3 to 12 carbon atoms, and halogenohydrocarbons having from 1 to 6 carbon atoms. These ethers, ketones and esters may have a cyclic structure. Compounds having at least two functional groups of ethers, ketones and esters (or that is, —O—, —CO— and —COO—) are also usable as the solvent. The solvent may have any other functional group such as an alcoholic hydroxyl group. Of the solvent having 2 or more functional groups, the carbon number may fall within the range defined for the compound having any of those functional groups.

Examples of the ethers having from 3 to 12 carbon atoms include diisopropyl ether, dimethoxymethane, dimethoxyethane, 1,4-dioxane, 1,3-dioxolan, tetrahydrofuran, anisole and phenetol.

Examples of the ketones having from 3 to 12 carbon atoms include acetone, methyl ethyl ketone, diethyl ketone, diisobutyl ketone, cyclohexanone and methylcyclohexanone.

Examples of the esters having from 3 to 12 carbon atoms include ethyl formate, propyl formate, pentyl formate, methyl acetate, ethyl acetate and pentyl acetate.

Examples of the organic solvents having 2 or more functional groups include 2-ethoxyethyl acetate, 2-methoxyethanol and 2-butoxyethanol.

Preferably, the carbon number of the halogenohydrocarbon is 1 or 2, most preferably 1. The halogen of the halogenohydrocarbon is preferably chlorine. The proportion of the hydrogen atoms of the halogenohydrocarbon substituted with halogen is preferably from 25 to 75 mol %, more preferably from 30 to 70 mol %, even more preferably from 35 to 65 mol %, most preferably from 40 to 60 mol %. Examples of the halogenohydrocarbons include dichloromethane, chloroform, methyl chloride, carbon tetrachloride, trichloroacetic acid, methyl bromide, methyl iodide, tri(tetra)chloroethylene, etc. Preferably, the halogenohydrocarbon contains at least dichloromethane.

In the invention, preferably, the solvent contains a poor solvent in a ratio of from 3 to 30% by weight, more preferably in a ratio of from 5 to 20% by weight. Containing a poor solvent within the above-mentioned range is preferred, since miscibility of the solvent with cellulose acylate increases and the haze of the film to be formed tends to lower.

Preferably, the boiling point of the poor solvent is not higher than 120° C., more preferably from 40 to 100° C. The boiling point not higher than 120° C. is preferred, since the evaporation speed of the solvent could be higher. Preferred examples of the poor solvent of the type include methanol, ethanol, propanol, butanol and water; and more preferred is methanol.

The dope for use in the invention is preferably so controlled that the amount of the cellulose acylate therein could be from 10 to 40% by mass, more preferably from 10 to 30% by mass.

The dope may be prepared according to ordinary methods. Ordinary methods are meant to include treatment at a temperature not lower than 0° C. (room temperature or high temperature). For preparing the dope, usable are any preparation method and apparatus for ordinary solvent casting methods. The dope may be prepared by stirring cellulose acylate and solvent at room temperature (0 to 40° C.). A high-concentration solution may be prepared by stirring them under pressure and under heat. Concretely, cellulose acylate and solvent are put into a pressure chamber and closed, and stirred therein under pressure at a temperature not lower than the boiling point of the solvent under normal pressure, with heating at a temperature falling within a range within which the solvent does not boil. The heating temperature is generally not lower than 40° C., preferably from 60 to 200° C., more preferably from 80 to 110° C.

The solution may be prepared by mixing and dissolving the starting resin and others in a solvent according to a well-known method, or may be prepared by swelling the starting resin and others with a solvent, then cooling the swollen mixture to −10° C. or lower and thereafter heating it up to 0° C. or higher, according to a cooling dissolution method. The viscosity (50° C.) of the cellulose acylate dope thus prepared is preferably within a range of from 50 to 100 P (poise, or that is, from 5 to 10 Pa·s).

The ingredients may be put into a chamber (tank, etc.), after roughly premixed, or may be put into it successively. The chamber must be so designed that the ingredients can be stirred therein. An inert gas such as nitrogen gas or the like may be introduced into the chamber to pressurize it. Increase in the vapor pressure of the solvent by heating may be utilized here. As the case may be, the ingredients may be introduced into the chamber under pressure after the chamber is closed.

In case of heating, preferably, the chamber is heated from the outside thereof. For example, a jacket-type heating unit may be employed. A plate heater may be provided outside the chamber, in which a pipe line may be arranged and a liquid may be circulated therethrough to thereby heat the whole chamber.

Preferably, a stirring blade is arranged inside the chamber, in which the ingredients are stirred with the blade. Preferably, the length of the stirring blade is so designed that the blade can reach around the inner wall of the chamber. Preferably, at the tip of the stirring blade, a scraper is provided for renewing the liquid film around the inner wall of the chamber.

The chamber may be equipped with various meters such as a pressure meter, a thermometer, etc. The ingredients are dissolved in the solvent in the chamber. The prepared dope is taken out of the chamber after cooled; or after taken out, it may be cooled with a heat exchanger or the like.

### (Filtration)

Next, the cellulose acylate dope is preferably filtered, using a filter unit that comprises a suitable filter member such as filter paper or the like (hereinafter this may be referred to as a filter). The filter unit for use in the invention is not specifically defined.

The filter unit is classified into a continuous type and a batch type depending on the operation mode thereof, any of which is employable here. As the continuous type filter unit, known are a drum filter, a disc filter, a belt filter, and a screw press; and as the batch type filter unit, known are a Nutsche filter, a leaf filter, a filter press and a Schneider filter.

Of those, preferred are continuous system filter units.

The filter unit is classified into a gravity type, a vacuum type, a pressure type, a suction type and a centrifugal type depending on the separation mode thereof, any of which is employable here.

As the gravity type filter unit, known are a rotary screen, a sand filter, a Nutsche filter; as the vacuum type filter unit, known are a drum filter, a Young filter, a disc filter, a horizontal filter, a horizontal belt filter, a Nutsche filter, a leaf filter; as the pressure type filter unit, known are a pressure type precoat filter, a pressure type scraper disc charge filter, a bag filter, a filter press, a Schneider filter, an automatic Nutsche filter; and as the suction type filter unit, known are a belt press, a screw press, a tube press, a Mars press, etc.

Of those, preferred is use of vacuum type or pressure type filters.

For the filtration, one filtration part may be provided in the filter; or multiple filtration parts may be provided therein for multistage filtration. The filtration accuracy of the filter material is preferably higher; however, in view of the pressure resistance of the filter material and of the filtration pressure increase owing to clogging of the filter material, preferred is use of a filter material capable of being controlled by changing the number of the sheets thereof to be loaded in a filter unit, for the purpose of securing the pressure resistance and the aptitude of the filter life. The type of the filter is not specifically defined, but a metal filter is preferred. The material of the metal filter may be any metal not causing corrosion or peeling, and for example, there may be mentioned industrially-available stainless steel, Hastelloy (trade name), nickel, nickel alloys, etc. As the metal filter for use for filtration in the invention, any ordinary one is employable with no specific limitation. Concretely, there are mentioned a leaf disc type, a candle filter type, a leaf type, a screen mesh, etc. Preferred is a leaf disc type, with which the residence time could be relatively short and the filtration area could be large.

Regarding the constitution of the filter material usable herein, there are mentioned those produced by knitting linear materials, as well as sintered filter materials produced by firing and sintering metal long fibers or metal powders, and metal fibers/powders laminate type filter material. From the viewpoint of the filtration accuracy and the filter life, preferred are sintered filter materials.

Preferably, the dope to be used in producing the polarizer protective film of the invention is filtered through a filter unit comprising a Schneider filter, a leaf filter, a disc filter or a leaf disc filter, more preferably a filter unit comprising a Schneider filter or a leaf disc filter. Of those, even more preferred for the filtration is a filter unit comprising a leaf disc filter in which the residence time is short and there occurs little drift.

The shape of the center pole of the filter includes an outer flow type, a hexagonal column inner flow type, a circular column inner flow type, etc., any of which is selectable for use herein so far as the residence time therein could be shortened.

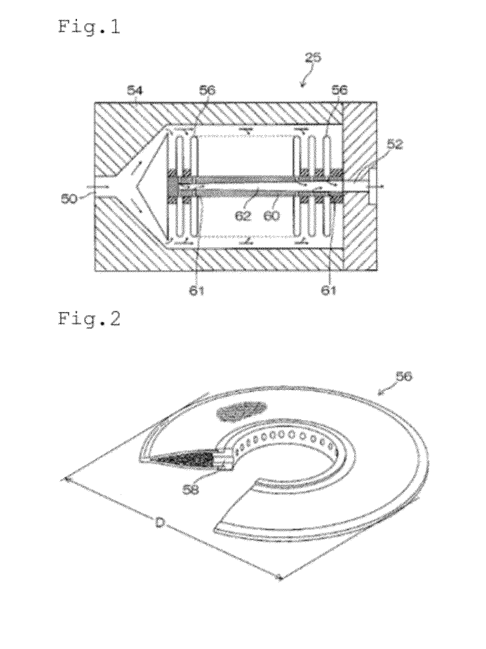

A preferred embodiment of the filter unit comprising leaf disc filters is described with reference to FIG. 1 and FIG. 2.

As shown in FIG. 1, the filter unit 25 comprising leaf disc filters mainly comprises a cylindrical filter housing 54 having a supply port 50 and a discharge port 52 for the above-mentioned dope, and multiple disc-shaped metal filters (leaf disc filters) 56 arranged inside the filter housing 54. FIG. 2 is an outline view showing the leaf disc filter 56. Preferably, the leaf disc filter 56 has a large number of pores each having a pore size of from 0.1 μm to 50 μm. In the leaf disc filter 56, formed is a filtration flow path so that the filtered dope could run into flow channel 62. The diameter D of the leaf disc filter 56 may be suitably determined depending on the flow rate of the dope and on the residence time thereof. Accordingly, the dope is fed into the disc-like leaf disc filter 56 from the supply port 50, then filtered from the outside of the leaf disc filter 56 into the filtration flow path, then made to run through the flow path via the hole 61 formed in the shaft 60, and thereafter discharged out of the discharge port 52. Processed through the filter unit 25, fine impurities including hemicellulose are removed from the dope.

Preferably, the absolute filtration rating of the filter unit is at most 15 μm, more preferably at most 1 μm.

Preferably, the viscosity of the dope that passes through the filter unit is from 15 to 40 Pa·s, more preferably from 15 to 30 Pa·s, even more preferably from 15 to 25 Pa·s.

Preferably, the temperature of the dope that passes through the filter unit is from 10 to 40° C., more preferably from 10 to 35° C., even more preferably from 15 to 35° C.

Preferably, the pressure of the dope that passes through the filter unit is from 1.0 to 2.5 MPa, more preferably from 1.0 to 2.0 MPa, even more preferably from 1.0 to 1.6 MPa.

Preferably, the variation in the discharge pressure of the dope that passes through the filter unit is from 0 to 2%, more preferably from 0 to 1.5%, even more preferably from 0 to 1%.

Thus filtered, not only fine insolubles and impurities such as unesterified cellulose but also other finer unnecessary matters such as semicellulose and others that form bright spots having a diameter of from 1 μm to less than 10 μm can be effectively removed from the dope.

### (Casting)

Preferably in the invention, the polarizer protective film of the invention is produced from the dope prepared as above, according to a solvent casting method.

As the method and the equipment for producing the polarizer protective film of the invention, usable are the same solution casting film formation method and the same solution casting film formation apparatus as those used in producing ordinary cellulose acetate films. The prepared dope (cellulose acylate solution) is taken out of the dissolver (tank) and is once stored in a storage tank, in which the dope is defoamed to prepare a final dope to be used in film formation. Preferred is use of a pressure die in which the slit form of the die nozzle can be designed in a desired manner and through which a film having a uniform thickness is easy to form. The pressure die includes a coat hanger die, a T die, etc., any of which is preferably employed here. The surface of the metal support is mirror-finished. For increasing the film formation speed, two or more pressure dies may be provided on the metal support and the dope amount may be divided for multilayer film formation. As the case may be, also preferred is a co-casting method of co-casting multiple dopes to produce a multilayer film.

One preferred casting mode is as follows: The dope is fed to the pressure die, for example, via a pressure-type metering gear pump via which a constant amount of the dope can be fed with high accuracy depending on the rotation number thereof, and the dope is thereby uniformly cast through the slit of the pressure die onto the metal support of an endlessly-running casting part, and at the peeling point at which the metal support has made almost a full circle, the undried dope film (this may be called a web) is peeled from the metal support. While sides of the thus-formed web are clipped, the web is conveyed with a tenter and dried, and subsequently finally dried while conveyed with rolls in the next drying unit, and thereafter wound up with a winding unit to a predetermined length. The combination between the tenter and the drying unit with rolls can be varied depending on the object of the film to be produced. In a solution casting film formation method for the polarizer protective film for use in liquid-crystal display devices, coating units are often added to the apparatus in addition to the solution casting film formation unit, for additional surface treatment for the films to form an undercoat layer, an antistatic layer, an antihalation layer, a protective layer and others thereon. The production steps are described briefly hereinunder, to which, however, the invention is not limited.

Preferably, the prepared dope is cast onto an endless metal support, for example, a metal drum or a metal support (band or belt), on which the solvent is evaporated away to form a film. Preferably, the concentration of the dope to be cast is controlled such that the cellulose content falls within a range of from 10 to 35% by mass. Preferably, the surface of the drum or the band is mirror-finished. The casting and drying method in a solvent casting method is described in U.S. Pat. Nos. 2,336,310, 2,367,603, 2,492,078, 2,492,977, 2,492,978, 2,607,704, 2,739,069, 2,739,070; BP 640731, 736892; JP-B 45-4554, 49-5614; JP-A 60-176834, 60-203430, 62-115035.

In addition, the cellulose acylate film formation techniques described in JP-A 2000-301555, 2000-301558, 7-032391, 3-193316, 5-086212, 62-037113, 2-276607, 55-014201, 2-111511 and 2-208650 is applicable to the invention.

Preferably, the dope is cast onto a drum or a band having a surface temperature of not lower than 30° C., and more preferably, the metal support temperature is from −50 to 20° C. In the production method of the invention, preferably, the dope cast onto the metal support is dried by applying thereto dry air onto both sides of the surface and the back of the metal support. Preferably, the dope is dried by applying air thereto for at least 2 seconds after casting on the support. The formed film is peeled away from the drum or the band, and dried with high-temperature air of which the temperature is varied successively from 100° C. to 160° C., whereby the residual solvent may be evaporated away from the film. The method is described in JP-B 5-17844. According to the method, the time to be taken from casting to peeling can be shortened. In carrying out the method, the dope must be gelled at the surface temperature of the drum or the band on which the dope is cast.

In the production method of the invention, two or more different types of dopes, which differ in point of the total degree of acylation of the cellulose acylate therein, may be used and the dopes may be co-cast onto the support.

In case where the film is produced according to the co-casting method or successive-casting method, first, the cellulose acylate solutions (dopes) for the constitutive layers are prepared. In the co-casting method (multilayer simultaneous casting method), co-casting dopes are simultaneously extruded out through a casting Giesser through which the individual casting dopes for the intended layers (the layers may be three or more layers) are simultaneously cast via different slits onto a casting support (band or drum), and at a suitable time, the film formed on the metal support is peeled away and dried.

The successive-casting method is as follows: First the dope for the first layer is extruded out and cast onto a casting support through a casting Giesser, then after it is dried or not dried, the casting dope for the second layer is cast onto it in a mode of extrusion through a casting Giesser, and if desired, three or more layers are successively formed in the same mode of casting and lamination, and at a suitable time, the resulting laminate film is peeled away from the support and dried. The coating method is generally as follows: A film of a core layer is formed according to a solution casting method, then a coating solution for surface layer is prepared, and using a suitable coater, the coating solution is applied onto the previously formed core film first on one surface thereof and next on the other surface thereof, or simultaneously on both surfaces thereof, and the resulting laminate film is dried.

### (Peeling)

Preferably, the production method in the invention includes a stretching step to be mentioned below, after the step of peeling the web, from which the solvent has been evaporated away on the metal support, at a peeling position. The peeled web is then fed to the next step in any desired manner. When the residual solvent amount in the web to be peeled is too large, then the web may be difficult to peel, or on the contrary, when the web is too much dried on the metal support and then peeled, then a part of the web may be broken or cut along the way.

In this, as a method of increasing the film formation speed (in which the film formation speed may be increased by peeling the web at a time when the residual solvent amount is as large as possible), there may be mentioned a gel casting method. For example, there are a method of adding a poor solvent for cellulose acylate to the dope, then casting the dope and gelling it; and a method of gelling the dope with lowering the temperature of the metal support. The dope may be gelled on the metal support to thereby increase the strength of the film to be peeled, thereby increasing the film formation speed.

Preferably, the residual solvent amount in the web on the metal support in peeling the web is controlled to fall within a range of from 5 to 150% by mass, depending on the condition of the drying load intensity, the length of the metal support, etc. However, in case where the web is peeled at a time when the residual solvent amount therein is larger, the residual solvent amount in peeling will be determined in consideration of both the economical film formation speed and the film quality. In the invention, the temperature of the peeling position on the metal support is preferably from −50 to 40° C., more preferably from 10 to 40° C., most preferably from 15 to 30° C.

The method of drying the web that has been dried on the drum or the belt and peeled away from it is described. The web that has been peeled away at the peeling position just before the drum or the belt has gone round is preferably conveyed according to a method where the web is introduced alternately into rolls arranged zigzag, or according to a method where the peeled web is conveyed in a noncontact mode with held with clips on both sides thereof.

The web may be dried according to a method in which air at a predetermined temperature is applied to both surfaces of the web (film) being conveyed, or according to a method of using a heating means such as microwaves, etc. Rapid drying may detract from the surface smoothness of the film to be formed, and therefore, preferably, in the initial stage of drying, the web is dried at a temperature at which the solvent does not foam, and after dried in some degree, the web is further dried at a high temperature. In the drying step after peeling from the support, the film tends to shrink in the machine direction or in the cross direction owing to evaporation of the solvent. The shrinkage may be larger when the film is dried at a higher temperature. Preferably, the film is dried with preventing the shrinkage thereof as much as possible as the surface smoothness of the formed film could be bettered more. From this viewpoint, preferred is a method where both sides of the web being dried are held with clips or pins for securing the width thereof in the cross direction in a part or all of the drying step (tenter system), for example, as shown in JP-A 62-46625. Preferably, the drying temperature in the drying step is from 100 to 145° C. The drying temperature, the dying air amount and the drying time may vary depending on the type of the solvent to be used; and the drying parameters may be suitably selected depending on the type and the combination of the solvents to be used.

### (Stretching Step)

Preferably, the production method for the polarizer protective film of the invention includes a step of stretching the web (film) in the film traveling direction (machine direction, MD) or in the direction transverse to the film traveling direction.

### (1) MD Stretching:

In the production method of the invention, preferably, the draw ratio in stretching the film in the film traveling direction is from 5 to 25%, more preferably from 8 to 22%.

The “draw ratio in stretching (%)” as referred to herein is defined by the following formula:

Draw Ratio in stretching(%)=100×{(length after stretching)−(length before stretching)}/(length before stretching)

The method of stretching the film in the film traveling direction is not specifically defined. For example, there are mentioned a method where multiple rolls are prepared and are controlled to have a different peripheral speed, and the film is made to run through the rolls and is thereby stretched in the machine direction by utilizing the difference in the peripheral speed between the rolls; a method where both sides of the film are held by clips or pins and the distance between the clips or the pins is expanded in the running direction to thereby stretch the film in the machine direction; or a method where the clips or the pins are expanded both in the machine direction and in the transverse direction to thereby stretch the film in both the machine direction and the transverse direction. As a matter of course, these methods may be used in combination. In the tenter method, preferably, the clips are driven according to a linear drive system, since the film can be stretched smoothly and since the risk of film breakage can be reduced. For the machine direction stretching, preferably used is an apparatus having two nip rolls, in which the rotation speed of the nip roll on the inlet port side is made higher than the rotation speed of the nip roll on the outlet port side whereby the cellulose acylate film can be stretched in the traveling direction (machine direction) in a favorable manner. Stretched in the manner as above, the retardation expression of the film can be favorably controlled.

In the production method of the invention, preferably, the film is stretched in the film traveling direction or in the direction transverse to the film traveling direction at a temperature T satisfying the following formula (iii). The stretching temperature in stretching the film in the film traveling direction or in the direction transverse to the film traveling direction may satisfy the following formula (iii); however, in the production method of the invention, preferably, both the stretching in the film traveling direction and the stretching in the direction transverse to the film traveling direction satisfy the temperature T of the following formula (iii).

Tg−15° C.≦stretching temperature T<Tg+25° C. (iii)

In stretching the film in the film traveling direction, preferably, the stretching temperature T is from Tg−5° C. to Tg+15° C.

### (2) TD Stretching:

Preferably, the draw ratio in stretching the film in the direction transverse to the film traveling direction is from 15 to 60%, more preferably from 20 to 50%.

The method of stretching the film in the direction transverse to the film traveling direction is not specifically defined. For example, there are mentioned a method where both sides of the film are held by clips or pins and the distance between the clips or the pins is expanded in the transverse direction to thereby stretch the film in the transverse direction, or a method where the distance between the clips or the pins is expanded simultaneously in both the machine direction and the transverse direction to thereby stretch the film in both the machine direction and the transverse direction. Needless-to-say, these methods may be combined. In the tenter method, preferably, the clips are driven according to a linear drive system, since the film can be stretched smoothly and since the risk of film breakage can be reduced. In the invention, the tenter unit is preferably used in the method of stretching the film in the direction transverse to the film traveling direction.

In stretching the film in the direction transverse to the film traveling direction in the production method of the invention, the preferred range of the stretching temperature T is the same as the preferred range of the stretching temperature in stretching the film in the film traveling direction as mentioned above.

### (3) Embodiment of Biaxial Stretching:

In the production method of the invention, the film may be stretched in the film traveling direction and in the direction transverse to the film traveling direction, either successively or simultaneously.

### (Winding)

As the winder for winding the formed film, herein usable is any winder generally used in the art. Briefly, the film can be wound up according to various winding methods, for example, according to a constant tension method, a constant torque method, a tapered tension method, or a programmed tension control method where the internal stress is kept constant. Preferably, the cellulose acylate film thus produced in the manner as above is such that the slow axis direction thereof is tilted by ±2 degrees relative to the winding direction (film length direction), more preferably by ±1 degree. Also preferably, slow axis direction of the film is tilted by ±2 degrees relative to the direction perpendicular to the winding direction (film width direction), more preferably by ±1 degree. Especially preferably, the slow axis direction of the film is tilted by ±0.1 degrees relative to the winding direction (film length direction). Also preferably, the slow axis direction of the film is tilted by ±0.1 degrees relative to the film width direction.

### <Characteristics of Polarizer Protective Film>

### (Number of Bright Spots)

In the polarizer protective film of the invention, the number of the bright spots having a diameter of from 0.1 μm to less than 10 μm, as measured according to the above-mentioned observation method, is at most 500/cm². More preferably, in the polarizer protective film of the invention, the number of the bright spots having a diameter of from 0.1 μm to less than 10 μm is at most 300/cm², even more preferably less than 150/cm².

The polarizer protective film of the invention is preferably a polarizer protective film for liquid-crystal display devices where the length L of the BGR short side of the panel pixel is (20 μm≦L≦100 μm) and in which the number of the bright spots as observed according to the observation method stated above and having a diameter of not larger than L/10 is at most 500/cm², more preferably at most 300/cm², and even more preferably at most 150/cm².

Preferably, in the polarizer protective film of the invention, the number of the bright spots having a diameter of from 10 μm to less than 50 μm, as measured according to the above-mentioned observation method, is at most 100/cm², more preferably at most 50/cm², even more preferably at most 10/cm².

Preferably, in the polarizer protective film of the invention, the number of the bright spots having a diameter of 50 μm or more, as measured according to the above-mentioned observation method, is at most 100/cm², more preferably 0.

### (Retardation)

Preferably, the in-plane retardation Re at a wavelength of 590 nm of the polarizer protective film of the invention satisfies −5 nm≦Re≦70 nm, and the thickness-direction retardation Rth thereof satisfies 60 nm≦Rth≦300 nm. To that effect, preferably, the polarizer protective film of the invention can be used as the retardation film in a liquid-crystal display device, directly as it is therein.

More preferably, Re of the polarizer protective film of the invention is from −5 to 60 nm, even more preferably from −5 to 5 nm.

More preferably, Rth of the polarizer protective film of the invention is from 60 to 200 nm, even more preferably from 70 to 150 nm.

Preferably, the in-plane retardation Re at a wavelength of 590 nm of the polarizer protective film of the invention satisfies −5 nm≦Re≦5 nm, the thickness-direction retardation Rth thereof satisfies 0 nm≦Rth≦150 nm, and the degree of acyl substitution of the cellulose acylate in the film is from 2.2 to 2.5.

In this description, Re (λ) and Rth (λ) each mean the in-plane retardation and the thickness-direction retardation, respectively, of the film at a wavelength of λ. Unless otherwise specifically indicated in this description, the wavelength λ is 590 nm. Re(λ) is measured by applying a light having a wavelength of λ nm to a film sample in the normal direction of the film, using KOBRA 21ADH or WR (by Oji Scientific Instruments). In selecting the wavelength for measurement, λ nm, the wavelength selection filter is exchanged by hand operation or the found data are converted by a program or the like to thereby determine the measurement wavelength.

In case where the film to be analyzed can be expressed as a monoaxial or biaxial index ellipsoid, Rth (λ) thereof is computed according to the method mentioned below.

Based on Re (λ) mentioned above, Rth (λ) is determined as follows: With the in-plane slow axis (determined by KOBRA 21ADH or WR) taken as the tilt axis (rotation axis) of the film (in case where the film has no slow axis, the rotation axis of the film may be in any in-plane direction of the film), Re (λ) of the film is measured at 6 points in all thereof, from the normal direction of the film up to 50 degrees on one side relative to the normal direction thereof at intervals of 10°, by applying a light having a wavelength of λ nm from the tilted direction of the film. Based on the thus-determined retardation data, the assumptive mean refractive index and the inputted film thickness, Rth (λ) of the film is computed with KOBRA 21ADH or WR.

In the above, in the case of a film having a direction in which the retardation value thereof is zero at a certain tilt angle relative to the in-plane slow axis, as the rotation axis, in the normal direction, the sign of the retardation value at a tilt angle larger than that tilt angle is changed to negative, and then the data are computed with KOBRA 21ADH or WR.

Apart from this, Rth may also be measured as follows: With the slow axis taken as the tilt axis (rotation axis) of the film (in case where the film has no slow axis, the rotation axis of the film may be in any in-plane direction of the film), the retardation is measured in any desired two directions, and based on the thus-determined retardation data, the assumptive mean refractive index and the inputted film thickness, Rth is computed according to the following formulae (3) and (3′).

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 3 )$$

In this, Re (θ) means the retardation of the film in the direction tilted by an angle θ from the normal direction to the film. In the formula (3), nx means the refractive index in the in-plane slow axis direction; ny means the refractive index in the direction perpendicular to nx in the plane; and nz means the refractive index in the direction perpendicular to nx and ny. d means the film thickness.

Rth={(nx+ny)/2−nz}×d (3′)

In case where the film to be analyzed could not be expressed as a monoaxial or biaxial index ellipsoid, or that is, in case where the film does not have an optic axis, Rth(λ) thereof is computed according to the method mentioned below.

Based on Re(λ) mentioned above, Rth(λ) is determined as follows: With the in-plane slow axis (determined by KOBRA 21ADH or WR) taken as the tilt axis (rotation axis) of the film, Re(λ) of the film is measured at 11 points in all thereof in the direction tilted by from −50 degrees to +50 degrees relative to the film normal direction at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above measurement, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethyl methacrylate (1.49), polystyrene (1.59). With the assumptive mean refractive index and the film thickness inputted thereinto, KOBRA 21ADH or WR can compute nx, ny and nz. From the thus-computed data nx, ny and nz, Nz=(nx−nz)/(nx−ny) is induced.

### (Film Thickness)

The thickness of the polarizer protective film of the invention can be suitably determined depending on the type of the polarizer to which the film is applied. Preferably, the thickness is from 30 to 80 μm, more preferably from 35 to 75 μm, even more preferably from 40 to 70 μm. When the thickness of the polarizer protective film is at most 80 μm, the production cost of the film can be reduced favorably.

### (Layer Configuration)

The polarizer protective film of the invention may be a single-layer film or may have a laminate structure of 2 or more layers. Also preferably, the polarizer protective film of the invention has a three-layered laminate structure. Specifically, the polarizer protective film of the invention preferably comprises outer layers for the two surfaces of the film and an inner core layer sandwiched between the two outer layers. In this case, the outer layer of the film on the side thereof kept in contact with the support in the film production may be referred to as a band-facing layer, and the other outer layer opposite thereto may be referred to as an air-facing layer.

### [Polarizer]

The polarizer of the invention comprises a polarizing element and the polarizer protective film of the invention.

The polarizer is formed by sticking and laminating the protective film onto at least one side of the polarizing element. As the polarizing element, usable is any known one. For example, a hydrophilic polymer such as a polyvinyl alcohol film is processed with a dichroic dye such as iodine and stretched to prepare the polarizing element. The cellulose acylate film may be stuck to the polarizing element in any desired manner with no specific limitation thereon; however, preferably, the two are stuck together with an adhesive of an aqueous solution of a water-soluble polymer. Preferably, the water-soluble polymer adhesive is an aqueous solution of a completely-saponified polyvinyl alcohol.

### [Liquid-Crystal Display Device]

The liquid-crystal display device of the invention comprises the polarizer protective film of the invention or the polarizer of the invention.

In a configuration of polarizer protective film/polarizing element/polarizer protective film/liquid-crystal cell/polarizer protective film/polarizing element/polarizer protective film, the polarizer protective film of the invention can be favorably used as any of those polarizer protective films therein.

In particular, the polarizer protective film of the invention can be stuck to a TN-mode, a VA-mode or an OCB-mode liquid-crystal cell, thereby providing a liquid-crystal display device excellent in viewing angle latitude, excellent in visibility with little coloration and excellent in in-plane uniformity. Above all, the polarizer protective film is especially preferably stuck to a VA-mode liquid-crystal cell.

### (High-Definition Liquid-Crystal Display Device)

Preferably, the liquid-crystal display device of the invention has a pixel size of such that the length L of the RGB short side thereof is from 20 μm to 200 μm, and more preferred is a high-definition liquid-crystal display device having a pixel size of 20 μm≦L≦100 μm. The polarizer protective film of the invention can prevent bright spot failures even in such a high-definition liquid-crystal display device.

### EXAMPLES

The characteristic features of the invention are described more concretely with reference to the following Examples and Comparative Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

### Examples 1 to 4 and Comparative Example 1

### (1) Preparation of Cellulose Acylate Dope

### (1) Dope Preparation:

### <1-1> Cellulose Acylate Solution:

The following ingredients were put into a mixing tank and dissolved by stirring. The mixture was heated at 90° C. for about 10 minutes, and filtered through paper filter having a mean pore size of 34 μm and through a sintered metal filter having a mean pore size of 10 μm.

Cellulose Acetate Solution

| | | |
|---|---|---|
| Cellulose Acetate | 100.0 | parts by mass |
| Additive 1 shown in Table 1 below | 9.0 | parts by mass |
| Additive 2 shown in Table 1 below | 0 to 10 | parts by mass |
| Dichloromethane | 403.0 | parts by mass |
| Methanol | 60.2 | parts by mass |

### <1-2> Mat Agent Dispersion:

Next, the cellulose acylate solution prepared in the above and a composition containing silica particles as a mat agent were put into a disperser to prepare a mat agent dispersion.

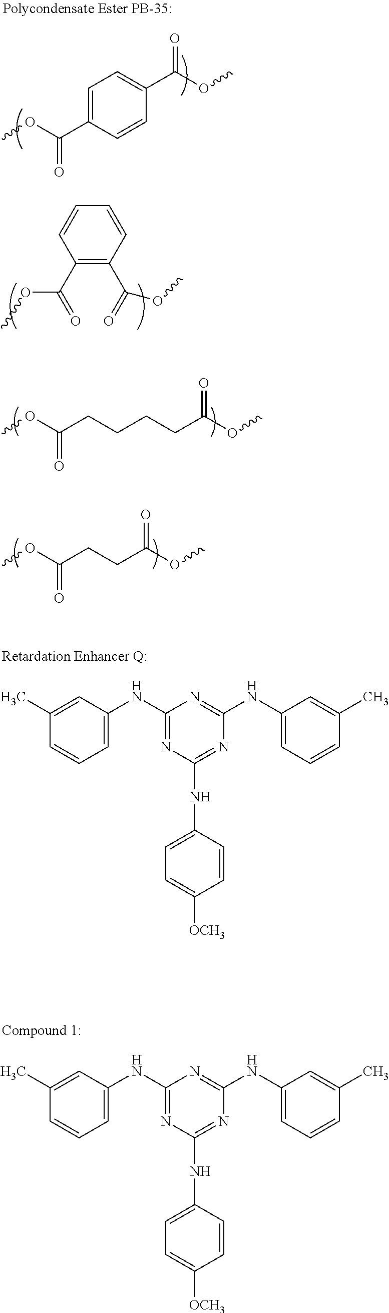

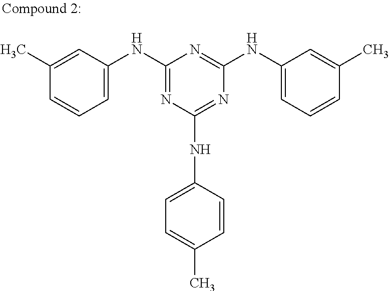

### (2) Filtration Step:

In Examples 1 to 3 and Comparative Example 1, the cellulose acylate dope prepared in the above was filtered at an absolute filtration rating of 10 μm.

In Example 4, the cellulose acylate dope prepared in the above was filtered, using a leaf disc filter at an absolute filtration rating 5 μm.

### (3) Film Formation

### (Casting Step)

The cellulose acylate dope filtered in the above was used. The dope in the stock tank was fed under feedback control with an inverter motor so that the primary pressure of the high-precision gear pump for primary pressurization could be 0.8 MPa. The high-precision gear pump had a volume efficiency of 99.3%, and the variation of the discharge power thereof was at most 0.4%. The discharge pressure of the pump was 1.4 MPa.

The casting die was equipped with a co-casting feed block having a width of 1.6 m, and was so designed that the mainstream could be laminated with side streams on both sides thereto to give a three-layer film. In the following description, the layer formed of the mainstream is referred to as an interlayer, the layer on the support side is referred to as a support-facing layer, and the other layer on the opposite side is referred to as an air-facing layer. The dope flow paths are three paths for the interlayer, the support-facing layer and the air-facing layer. In producing the film here, only the flow path for interlayer was used.

The polymer dope flow rate at the die nozzle was so controlled that the thickness of the finished polymer film could be 58 μm. For controlling the dope temperature to be 36° C., a jacket was applied to the casting die so that the inlet port temperature of the heat medium to be given into the jacket could be 36° C.

The die, the feed block and the pipeline were all kept at 36° C. during the operation. The die is a coat hanger die provided with thickness control bolts at a pitch of 20 mm and equipped with an automatic thickness controller with heat bolts. The heat bolts can define the dope flow rate profile in accordance with the flow rate of the high-precision gear pump as programmed previously, and based on the control program made on the basis of the profile of the infrared thickness meter installed in the film formation process, they enable feedback control. The casting process was so controlled that, in the formed film except the casting edges of 20 mm, the thickness difference between arbitrary two points as spaced from each other by 50 mm could be within 1 μm, and that the largest difference in the maximum value of the thickness in the cross direction could be at most 2 μm/m. On the primary side of the die, a chamber for depressurization was installed. The degree of depressurization in the depressurization chamber was so designed that a pressure difference of from 1 Pa to 5000 Pa could be applied to the unit before and after the casting beads, and could be controlled in accordance with the casting speed. In the case, the pressure difference was so controlled that the bead length could be from 2 mm to 50 mm.

### (Casting Die)

The material of the die is formed of a two-phase stainless steel having a mixed composition of an austenite phase and a ferrite phase, and has a thermal expansion coefficient of at most 2×10⁻⁵ (° C.⁻¹). The material has corrosion resistance on the same level as that of SUS316 in a forced corrosion test with an aqueous electrolytic solution. The finish accuracy of the liquid-facing surface of the casting die and the feed block was at most 1 μm in terms of the surface roughness, the straightness thereof was at most 1 μm/m in every direction, and the slit clearance could be automatically controlled within a range of from 0.5 mm to 3.5 mm. In producing films here, the clearance was 1.5 mm. The angle part of the liquid-facing side of the die lip tip was so worked that R thereof could be at most 50 μm in the entire width of the slit. The shear rate inside the die was within a range of from 1 (sec⁻¹) to 5000 (sec⁻¹).

At the lip tip of the casting die, a hardened film was provided. For the film, there may be mentioned tungsten carbide (WC), Al₂O₃, TiN, Cr₂O₃ and others, and preferred is WC. In the invention, the tip was coated with WC according to a flame coating method. A mixed solvent (dichloromethane/methanol/butanol, 83/15/2 by mass), which is a solvent for solubilizing the dope, was applied to the air/liquid interface between the bead end and the slit at a rate of 0.5 ml/min per one side. Further, for keeping the depressurization chamber at a constant temperature, the chamber was equipped with a jacket in which a heat medium controlled at 35° C. was circulated. The edge suction rate could be controlled within a range of from 1 L/min to 100 L/min, and in the film production in the present case, the suction rate was suitably controlled with a range of from 30 L/min to 40 L/min.

### (Metal Support)

A stainless endless band having a length of 100 m was used as the support. The thickness of the band was 1.5 mm, and the surface thereof was polished to have a surface roughness of at most 0.05 μm. The material of the band was SUS316, having sufficient corrosion resistance and strength. The thickness unevenness of the entire band was at most 0.5%. The band was driven by two drums, and the band tension was controlled to be 1.5×10⁴ kg/m. The relative speed difference between the band and the drums was at most 0.01 m/min. The band driving speed variation was at most 0.5%. Both side positions of the band were detected and controlled so that the meandering of the band in the width direction thereof in one rotation could be at most 1.5 mm. The position variation in the horizontal direction owing to drum rotation of the support surface just below the casting die was controlled to be at most 200 μm. The support was installed in a casing equipped with an air pressure vibration controlling means. The dope was cast onto the support via the die. The surface temperature in the center part of the support just before casting was 15° C. The temperature difference between both sides of the support was at most 6° C. The metal support must not have surface defects. Accordingly, the support used here had no pinholes in a size of 30 μm or more, and the number of pinholes in a size of from 10 μm to 30 μm therein was at most 1/m², and the number of pinholes in a size of at most 10 μm therein was at most 2/m².

### (Casting Drying)

The casting chamber with the casting die and the support installed therein was kept at a temperature of 35° C. The dope cast onto the band was first dried with parallel-flow drying air applied thereto. The overall heat transfer coefficient of the drying air to the dope in drying was 24 kcal/m²·hr·° C. The temperature of the drying air was 130° C. on the upstream side of the band top and was 135° C. on the downstream side thereof. The temperature at the lower part of the band was 65° C. The gas saturation temperature was at around −8° C. on every side. The oxygen concentration in the drying atmosphere on the support was kept at 5 vol. %. For keeping the oxygen concentration at 5 vol. %, air was purged with nitrogen gas. For condensing and collecting the solvent in the casting chamber, a condenser was installed, and its outlet port temperature was set at −10° C.

For 5 seconds after the casting, the drying air was prevented from being directly applied to the dope by the use of an air-blocking unit so that the static pressure fluctuation around the casting die was controlled to be within a range of ±1 Pa. At the time when the solvent ratio in the dope reached 45% by mass as the dry weight basis, the film was peeled from the casting support. The peeling tension was 8 kgf/m, and the peeling speed (peel roll draw) relative to the support speed was controlled within a range of from 100.1% to 110% so that the film could be suitably peeled. The surface temperature of the peeled film was 14° C. The drying speed on the support was 62% by mass (dry weight basis solvent)/min on average. The solvent gas generated in drying was introduced into the condenser unit, in which the gas was liquefied at −10° C. and collected, and this was recycled as the feeding solvent. The dry air from which the solvent had been removed was again heated and recycled as drying air. In the case, the water content of the solvent was controlled to be at most 0.5% before recycling it.

The peeled film was conveyed in a transfer area equipped with a large number of rollers. The transfer area had three rollers and its temperature was kept at 40° C. While conveyed by the rollers in the transfer area, the film was given a tension of from 16 N to 160 N.

### (Tenter Conveyance/Drying Step Condition)

The peeled film was conveyed in the drying zone of a tenter while both sides thereof were fixed with a clipping tenter, and dried therein with dry air. A heat transfer medium at 20° C. was supplied to the clips to cool them. The tenter was driven with a chain, and the speed variation of the sprocket was at most 0.5%. The inside of the tenter was divided into three zones, and the drying air temperature in those zones was 90° C., 100° C. and 110° C., respectively, from the upstream side thereof. Regarding the gas composition thereof, the drying air had a saturation gas concentration at −10° C. In the tenter, the mean drying speed was 120% by mass (dry weight basis solvent)/min. The drying zone condition was so controlled that the residual solvent amount in the film at the outlet port of the tenter could be at most 10% by mass, and in the film production in the present case, the residual solvent amount was 7% by mass. Inside the tenter, the film was stretched in the cross direction, while conveyed. The width expansion rate of the film was 103%, based on the width, 100%, of the film just conveyed into the tenter. The draw ratio from the peeling roller to the tenter inlet port (tenter drive draw) was 102%. The draw ratio inside the tenter was so designed that the substantial draw ratio difference in the part spaced by at least 10 mm from the tenter-biting part was at most 10% and the draw ratio difference between arbitrary two points spaced from each other by 20 mm was at most 5%.

The ratio of the length fixed by the tenter of the base end was 90%. The tenter clips were cooled so that the temperature thereof could not be higher than 50° C. and the film was conveyed under the condition. The solvent evaporated in the tenter part was concentrated and liquefied at a temperature of −10° C., and collected. A condenser was provided for liquid condensation and collection, and the outlet port temperature thereof was set at −8° C. The water content of the solvent was controlled to be at most 0.5% by mass in recycling the solvent.

Within 30 seconds from the tenter outlet port, both sides of the film were trimmed. Both sides of the film in a width of 50 mm were trimmed with an NT cutter. The oxygen concentration in the drying atmosphere in the tenter was kept at 5 vol. %. For keeping the oxygen concentration at 5 vol. %, air was purged with nitrogen gas. Before drying at a high temperature in the roller conveyance zone to be mentioned below, the film was preheated in a preheating zone in which drying air at 100° C. was kept supplied.

### (Post-Drying Step Condition)

The trimmed polymer film, as obtained according to the above-mentioned method, was dried at a high temperature in a roller conveyance zone. The roller conveyance zone was divided into 4 sections, into which drying air was kept supplied at 120° C., 130° C., 130° C. and 130° C., respectively, from the upstream side. In this, the roller conveyance tension of the film was 100 N/width, and the film was dried for about 10 minutes until the residual solvent amount therein could reach finally 0.3% by mass. The rollers used had a lap angle of 90 degrees and 180 degrees. Regarding the material thereof, the rollers were made of aluminium or carbon steel, and plated with a hard chromium coat on the surface thereof. Regarding the surface condition thereof, some of the rollers had a flat surface and some others were matted by blasting. The fluctuation by roller rotation was at most 50 μm in every case. The roller flexion at a tension of 100 N/width was controlled to be at most 0.5 mm.

A forced neutralization unit (neutralization bar) was installed in the process so that the electrostatic potential of the film being conveyed could fall all the time within a range of from −3 kV to 3 kV. In the winding part, not only such a neutralization bar but also an ionic air neutralization unit was installed so that the electrostatic potential of the film could be from −1.5 kV to 1.5 kV.

The dried film was conveyed into a first conditioning chamber. In the transfer part between the roller conveyance zone and the first conditioning chamber, dry air at 110° C. was supplied. In the first conditioning chamber, air having a temperature of 50° C. and having a dew point of 20° C. was supplied. Further, the film was conveyed into a second conditioning chamber where the film was prevented from curing. In the second conditioning chamber, the film was directly exposed to air at 90° C. and at a humidity of 70%.

### (Post Treatment/Winding Condition)

After dried, the polymer film was cooled to 30° C. or lower and trimmed at both sides thereof. For trimming the film, two film trimming units were installed on both sides of the film (or that is, the number of the trimming units on one side was 2), and the film was trimmed on both sides thereof. The trimming unit is composed of a disc-like rotating upper blade and a roll-like rotating lower blade, and the material of the rotating upper blade was a cemented steel material. The diameter of the rotating upper blade was 200 mm, and the blade thickness at the cutting part thereof was 0.5 mm. The material of the roll-like rotating lower blade was a cemented steel material, and the roll diameter of the rotating lower blade was 100 mm.

The obtained films were the polarizer protective films of Examples and Comparative Examples.

### (4) Production of Polarizer:

Iodine was adsorbed to a stretched polyvinyl alcohol film to prepare a polarizing element.

The cellulose acylate film of Example 1 was, after saponified, stuck to one side of the polarizing element with a polyvinyl alcohol adhesive. A commercially-available cellulose triacetate film, Fujitac TD80UF (by FUJIFILM), also after saponified similarly, stuck to the polarizing element with a polyvinyl alcohol adhesive on the side opposite to the side where the cellulose acylate film of Example 1 was stuck.

In this, the cellulose acylate film of Example 1 was so positioned that the transmission axis of the polarizing element could be parallel to the slow axis of the film. The commercial cellulose triacetate film was so positioned that the transmission axis of the polarizing element could be perpendicular to the slow axis of the film. Similarly, polarizers of Examples and Comparative Examples were produced.

### (5) Production of Ordinary Liquid-Crystal Display Device 1:

The obtained polarizer was stuck to the panel mentioned below.

Concretely, the polarizers on the front side and on the rear side were removed from a Sharp's liquid-crystal display, LC-32DE5 (RGB short side 180 μm) to prepare a panel, and the polarizer of Examples and Comparative Examples was positioned on the front side and the rear side of the liquid-crystal panel to construct a liquid-crystal display device.

### (6) Production of High-Definition Liquid-Crystal Display Device 2:

Similarly, the polarizer of Examples and Comparative Examples was positioned on the front side and the rear side of a liquid-crystal panel having an RGB short side of 70 μm to construct a high-definition liquid-crystal display device 2.

### <Test Method>

### (Film Optical Properties)

The in-plane retardation Re of the polarizer protective film of Examples and Comparative Examples was measured using an automatic birefringence meter KOBRA-WR (by Oji Instruments) according to the above-mentioned method for three-dimensional birefringence measurement at a wavelength of 590 nm; and the thickness-direction retardation Rth thereof was determined by measuring Re at different tilt angles.

The results are shown in Table 1 below.

### (Number of Bright Spots)

The polarizer protective film of Examples and Comparative Examples was checked for bright spots according to the method described hereinabove. Two polarizers were arranged on both sides of the film so as to prevent the incident light from running therethrough. Light was applied thereto on one side, and on the other side, the film was observed with an optical microscope (100 magnifications) to count and measure the number and the diameter of the bright spots seen therein.

The obtained results are shown in Table 1 below.

### (Bright Spot Failures)

The polarizer protective film of Examples and Comparative Examples was built in the ordinary liquid-crystal display device 1 and the high-definition liquid-crystal display device 2, and the devices were checked for bright spot failures, and evaluated according to the following standards.

A: The number of the bright spots seen in the panel was less than 50.
B: The number of the bright spots seen in the panel was from 50 to less than 200.
C: The number of the bright spots seen in the panel was from 200 to less than 400.
D: The number of the bright spots seen in the panel was 400 or more, and the panel is problematic in practical use.

The obtained results are shown in Table 1 below.

TABLE 1

| | | | | | | | | | | | | | | Character- | |
|---|---|---|---|---|---|---|---|---|---|---|---|---|---|---|---|
| | Film Formation Method | | | | | | | Characteristics of Polarizer Protective Film | | | | | | istics of | |
| | Dope Composition | | | | | | | | | | Number of Bright | | | Liquid- | |
| | Cellulose | | | | | | | | | | Spots per cm² | | | Crystal | |
| | Acylate | | | | Filtration | | | | | | (optical microscope × 100) | | | Device | |
| | de- | de- | | | | Fil- | | | | | dia- | dia- | | Bright Spot | |
| | gree | gree | | | | tra- | | | | | meter | meter | dia- | Failures | |
| | of | of | | | | tion | | | | film | 0.1 μm | 10 μm | meter | | high- |
| | sub- | sub- | | | | Rat- | | | | thick- | to less | to less | 50 μm | ordi- | defi- |
| | sti- | sti- | | | | ing | | Re | Rth | ness | than | than | or | nary | nition |
| | tution | tution | Additive 1 | Additive 2 | Unit | [mm] | Method | [nm] | [nm] | [μm] | 10 μm | 50 μm | more | panel | panel |
| Example 1 | 2.79 | Ac | PB-33 | — | Schneider | 10 | | 0 | 75 | 58 | 250 | 13 | 0 | B | C |
| | | | | | filter | | | | | | | | | | |
| Example 2 | 2.79 | Ac | PB-33 | Compound 1 | Schneider | 10 | | 0 | 112 | 44 | 260 | 13 | 0 | B | C |
| | | | | | filter | | | | | | | | | | |
| Example 3 | 2.79 | Ac | PB-33 | Compound 1 | Schneider | 10 | | 70 | 203 | 78 | 280 | 15 | 0 | B | C |
| | | | | | filter | | | | | | | | | | |
| Example 4 | 2.43 | Ac | PB-10 | — | leaf disc | 5 | | 55 | 120 | 59 | 240 | 10 | 0 | A | B |
| | | | | | filter | | | | | | | | | | |
| Comparative | 2.86 | Ac | Compound | Compound 2 | Schneider | 10 | | 7 | 96 | 80 | 600 | 30 | 0 | C | D |
| Example 1 | | | Q | | filter | | | | | | | | | | |

As in the above Table 1, it is known that the polarizer protective film of the invention can prevent bright spot failures in high-definition liquid-crystal display devices. On the other hand, in the polarizer protective film of Comparative Example 1, the number of the bright spots per cm² is more than the range defined in the invention, and it is known that the film could not prevent bright spot failures in high-definition liquid-crystal display devices.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2011-073708 filed on Mar. 29, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A polarizer protective film comprising a cellulose acylate of such that when two polarizers are arranged on both sides of the film so as to block a transmitted light from running through the film and when the film is irradiated with a light on one side thereof and observed with an optical microscope where the object lens has 10 magnifications and the eye lens has 10 magnifications, on the opposite side thereof, the number of the bright spots existing therein and having a diameter of from 0.1 μm to less than 10 μm is at most 500/cm².

2. The polarizer protective film according to claim 1, which is a polarizer protective film for liquid-crystal display devices where the length L of the BGR short side of the panel pixel is
20 μm≦L≦100 μm
and in which the number of the bright spots as observed according to the observation method stated in [1] and having a diameter of not larger than L/10 is at most 500/cm².

3. The polarizer protective film according to claim 1, wherein the number of the bright spots having a diameter of from 0.1 μm to less than 10 μm is at most 150/cm².

4. The polarizer protective film according to claim 1, wherein the number of the bright spots having a diameter of from 0.1 μm to less than 10 μm is from 11 to 150/cm².

5. The polarizer protective film according to claim 1, wherein the number of the bright spots having a diameter of from 1 μm to less than 10 μm is from 11 to 150/cm².

6. The polarizer protective film according to claim 1, wherein the degree of acyl substitution of the cellulose acylate is from 2.2 to 2.85.

7. The polarizer protective film according to claim 1, wherein the degree of acyl substitution of the cellulose acylate is from 2.2 to 2.5.

8. The polarizer protective film according to claim 1, of which the in-plane retardation Re at a wavelength of 590 nm satisfies
−5 nm≦Re≦70 nm
and the thickness-direction retardation Rth satisfies
60 nm≦Rth≦300 nm.

9. The polarizer protective film according to claim 1, of which the in-plane retardation Re at a wavelength of 590 nm satisfies
−5 nm≦Re≦5 nm
and the thickness-direction retardation Rth satisfies
70 nm≦Rth≦150 nm.

10. The polarizer protective film according to claim 9, wherein the degree of acyl substitution of the cellulose acylate is from 2.2 to 2.5.

11. The polarizer protective film according to claim 1, of which the in-plane retardation Re at a wavelength of 590 nm satisfies
−5 nm≦Re≦5 nm
and the thickness-direction retardation Rth satisfies
0 nm≦Rth≦150 nm.

12. The polarizer protective film according to claim 1, wherein the degree of acyl substitution of the cellulose acylate is from 2.2 to 2.5.

13. The polarizer protective film according to claim 1, which is formed in a mode of film formation with a dope containing the cellulose acylate filtered through a filter apparatus equipped with leaf disc filters.

14. The polarizer protective film according to claim 1, which is formed in a mode of film formation where a dope containing the cellulose acylate is cast onto a support.

15. The polarizer protective film according to claim 1, containing a polycondensate ester.

16. The polarizer protective film according to claim 1, wherein the cellulose acylate is a cellulose acetate.

17. A retardation film comprising a polarizer protective film, wherein the polarizer protective film comprises a cellulose acylate of such that when two polarizers are arranged on both sides of the film so as to block a transmitted light from running through the film and when the film is irradiated with a light on one side thereof and observed with an optical microscope where the object lens has 10 magnifications and the eye lens has 10 magnifications, on the opposite side thereof, the number of the bright spots existing therein and having a diameter of from 0.1 μm to less than 10 μm is at most 500/cm².

18. A polarizer comprising a polarizing element and at least one polarizer protective film, wherein the polarizer protective film comprises a cellulose acylate of such that when two polarizers are arranged on both sides of the film so as to block a transmitted light from running through the film and when the film is irradiated with a light on one side thereof and observed with an optical microscope where the object lens has 10 magnifications and the eye lens has 10 magnifications, on the opposite side thereof, the number of the bright spots existing therein and having a diameter of from 0.1 μm to less than 10 μm is at most 500/cm².

19. A liquid-crystal display device comprising a polarizer protective film, wherein the polarizer protective film comprises a cellulose acylate of such that when two polarizers are arranged on both sides of the film so as to block a transmitted light from running through the film and when the film is irradiated with a light on one side thereof and observed with an optical microscope where the object lens has 10 magnifications and the eye lens has 10 magnifications, on the opposite side thereof, the number of the bright spots existing therein and having a diameter of from 0.1 μm to less than 10 μm is at most 500/cm².

20. The liquid-crystal display device according to claim 19, equipped with a pixel of which the length of the BGR short side is from 20 μm to 200 μm.
